(19) United States
(12) Patent Application Publication
(10) Pub. No.: US 2025/0259153 A1
(43) Pub. Date: Aug. 14, 2025

(54) REAL-TIME IMAGE VALIDITY ASSESSMENT

(71) Applicant: Capital One Services, LLC, McLean, VA (US)

(72) Inventors: Shena YOSHIDA, Brooklyn, NY (US); Namfon THASANON, Jersey City, NJ (US); Ashwath KRISHNAN, New York, NY (US); Amith Kumar RAMACHANDRAN, Brunswick, NJ (US)

(73) Assignee: Capital One Services, LLC, McLean, VA (US)

(21) Appl. No.: 18/441,417

(22) Filed: Feb. 14, 2024

(51) Int. Cl. G06Q 20/04; G06Q 20/10; G06Q 20/32; G06Q 40/02; G06V 30/10

(52) U.S. Cl. CPC G06Q 20/042; G06Q 20/108; G06Q 20/3223; G06Q 40/02; G06V 30/10

(57) ABSTRACT

A computer implemented method, system, and non-transitory computer-readable device for a remote deposit environment. In some embodiments, a predictive machine learning (ML) model may be trained to determine a likelihood an image will be successfully processed via OCR. The predictive ML model may determine the likelihood prior to the image being uploaded to a remote server and/or processed via OCR, allowing the image to be rejected and replaced in real time. In some embodiments, the predictive ML model may be implemented on a mobile device. Optionally, the predictive ML model may be supported by a deep learning model operating to refine the predictive ML model.

### BACKGROUND

As financial technology evolves, banks, credit unions and other financial institutions have found ways to make online banking and digital money management more convenient for customers. Mobile banking apps may let you check account balances and transfer money from your mobile device. In addition, a customer may deposit paper checks from virtually anywhere using their smartphone or tablet. However, customers need to take images with, for example, a camera to have them processed remotely.

### BRIEF DESCRIPTION OF THE DRAWINGS

The accompanying drawings are incorporated herein and form a part of the specification.

FIG. 1 illustrates an example remote deposit check capture, according to some embodiments.

FIG. 2 illustrates example remote deposit OCR segmentation, according to some embodiments.

FIG. 3 illustrates an example block diagram of a remote deposit system architecture, according to some embodiments.

FIG. 4 illustrates an example flow diagram of a remote deposit system, according to some embodiments.

FIG. 5 illustrates an example block diagram of a client computing device, according to some embodiments.

FIG. 6 illustrates an example flow diagram of a machine learning (ML) system, according to some embodiments.

FIG. 7 illustrates an example flow diagram of a method, according to some embodiments.

FIG. 8 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing an image validity assessment on a mobile or desktop computing device to assist, in real-time, a customer electronically depositing a financial instrument, such as a check. The image validity assessment may be used to pre-determine the likelihood the image will be successfully processed via optical character recognition (OCR) to obtain deposit data. OCR is the electronic or mechanical conversion of images of typed, handwritten or printed text into machine-encoded text, whether from a scanned document, a photo of a document, a scene photo, stream of image data, etc. Utilizing OCR, data (e.g., check amount, signature, MICR line, account number, etc.) may be extracted from one or more images of a check and used to process a remote deposit.

Mobile check deposit is a fast, convenient way to deposit funds using a customer's mobile device or laptop. As financial technology and digital money management tools continue to evolve, the process has become safer and easier than ever before. Mobile check deposit is a way to deposit a financial instrument, e.g., a paper check, through a banking app using a smartphone, tablet, laptop, etc. Currently, mobile deposit allows a bank customer to capture a picture of a check using, for example, their smartphone or tablet camera and upload it through a mobile banking app running on the mobile device. Deposits commonly include personal, business or government checks.

Most banks and financial institutions use advanced security features to keep an account safe from fraud during the mobile check deposit workflow. For example, security measures may include encryption and device recognition technology. In addition, remote check deposit apps may capture check deposit information without storing the check images on the customer's mobile device (e.g., smartphone). Mobile check deposit may also eliminate or reduce typical check fraud as a thief of the check may not be allowed to subsequently make use of an already electronically deposited check, whether it has cleared or not, as remote deposit systems may provide an alert to the banking institution of a second deposit attempt. In addition, fraud controls may include mobile security alerts, such as mobile security notifications or SMS text alerts, which can assist in uncovering or preventing potentially fraudulent activity.

Currently, computer-based (e.g., laptop) or mobile-based (e.g., mobile device) technology allows a customer to initiate a document uploading process for uploading images or other electronic versions of a document to a backend system (e.g., a document processing system) for various purposes. In some cases, this technology does not or cannot sufficiently assess, prior to upload and/or further processing, whether images of documents will be able to be successfully processed at the backend system. For example, in some cases, this technology does not or cannot assess, prior to upload and/or further processing, whether images of documents will be able to be successfully processed using OCR to extract data necessary to complete deposits for the customer. Currently, image capture problems may be revealed by cancellations or additional requests to recapture images of the check after an OCR processing attempt, or a customer taking their deposit to another financial institution, causing a potential duplicate presentment fraud issue.

The restrictive approach of current systems is necessitated in certain document upload processes because such processes have automated routines for receiving the images, processing the images, and completing actions associated with the upload of the images. For example, a customer may utilize a mobile deposit application to upload an image of a document associated with a customer account, such as a check associated with the customer's bank account. Once initiated, the document upload and processing may continue until the image has been processed, either successfully or unsuccessfully, without any further input from the customer. This current approach is problematic because the customer is typically not given any information about the status of the image until after the process has completed, when it is too late to cancel or correct the upload and time and processing costs have been wasted.

These processes are more likely to cause increased error rates, processing costs, and customer frustration. The more accurately technology can determine, prior to upload and/or an OCR processing attempt, whether an image will be acceptable for processing a financial transaction, the more efficient and seamless the customer experience will be, and the fewer system and network resources will be required (such as memory space for storing images, processing time associated with processing invalid images, including OCR processing, and network resources associated with sending and receiving invalid images). For example, accurately predetermining that an image will be acceptable prior to image upload and/or further processing may prevent a customer being required to capture another picture because an image captured and sent to the backend system has been rejected. Accordingly, transaction processing delays may be reduced. Further, processing costs at the backend system may be reduced by accurately predetermining whether an image will be acceptable, as the backend system may be less burdened with performing OCR processing attempts, rejecting unusable images, communicating with a remote device to initiate image recapture, etc.

While existing processes (e.g., document alignment guides, instructions to hold a camera still while capturing an image, etc.) can provide some guard against the capture and upload of unusable images, the systems and methods disclosed herein may result in higher rates of acceptable images being submitted for OCR processing, leading to a more seamless customer experience and reduced processing costs, both at the customer's computing device and at the bank's backend system. In some embodiments, acceptability of an image refers to whether the image can be processed to extract data from the image (e.g., via OCR) that is necessary for processing a transaction (e.g., a remote deposit). In some embodiments, acceptability of an image may also refer to whether the image will pass various image quality checks (e.g., lighting checks, positioning checks, completeness checks, etc.) performed in existing remote deposit systems post image capture.

The technology described herein in the various embodiments implements a pre-deposit assessment of an image for features that may prevent the image from being used to complete a deposit. In some embodiments, the image may be assessed using an ML model operating on a customer's mobile device (e.g., a mobile phone). In some embodiments, the ML model may be trained using supervised or semi-supervised learning, for example, by providing a collection of categorized images (e.g., OCR pass/fail) of checks to an untrained or partially trained model to train a predictive ML model (e.g., a classification model and/or regression model). Upon being provided an image of a check, the predictive ML model may be configured to provide a likelihood the check image will be successfully processed via OCR (e.g., a confidence score). Using the confidence score or other indication of the likelihood from the predictive ML model, a mobile banking app operating on the customer's mobile device may provide an image acceptance status to the customer via a user interface (UI). Accordingly, the predictive ML model may be able to assess check images mid-experience. Implementing the technology disclosed herein, an image acceptance status may be rendered on a UI mid-experience.

In some embodiments, the image being assessed may be an image that has been captured by a camera of the customer's mobile device and stored within memory of the mobile device, either in permanent storage or temporary storage such as an image buffer. In some embodiments, the image being assessed may be an image frame that is part of a stream of live or continuously observed imagery. This imagery may be processed continuously, for example, in real-time, using the predictive ML model without first storing an image in permanent memory (or perhaps additionally without storing an image in an image buffer). In such alternative embodiments, the assessment of the image frame may be used to trigger automatic capture and at least temporary storage of the image frame. In some embodiments, live camera imagery may be streamed as encoded data configured as a byte array (e.g., as a Byte Array Output Stream object). The byte array may be a group of contiguous (side-by-side) bytes, for example, forming a bitmap image. This local processing solution may eliminate or reduce image storage requirements for image assessment using an ML model.

While described throughout for image assessment performed on the client device, in some embodiments, the image or live stream of imagery may be communicated to one or more remote computing devices or cloud-based systems for performing a remote image assessment, wherein the predictive ML model operates on the one or more remote computing devices or cloud-based systems. In such embodiments, the predictive ML model may still determine a likelihood of successful OCR processing prior to forwarding an image for further processing. In such embodiments, an image acceptance status may also be provided to a customer in real-time via a UI.

ML involves computers discovering how they can perform tasks without being explicitly programmed to do so. ML may include, but is not limited to, artificial intelligence, deep learning, fuzzy learning, supervised learning, unsupervised learning, etc. Machine learning algorithms may build a model based on sample data, known as “training data,” in order to make predictions or decisions without being explicitly programmed to do so. For supervised learning, the computer may be presented with example inputs and their desired outputs and the goal is to learn a general rule that maps inputs to outputs. In another example, for unsupervised learning, no labels may be given to the learning algorithm, leaving it on its own to find structure in its input. Unsupervised learning can be a goal in itself (discovering hidden patterns in data) or a means towards an end (feature learning).

A machine learning engine (e.g., operating on ML platform 329) may use various classifiers to map concepts associated with a specific image capture/OCR process to capture relationships between concepts (e.g., device movement data vs. OCR processing success). The classifier (discriminator) may be trained to distinguish (recognize) variations. Different variations may be classified to ensure no collapse of the classifier and so that variations can be distinguished.

In some embodiments, machine learning models may be trained on a remote machine learning platform (e.g., ML platform 329) using other customer's transactional information (e.g., previously submitted deposit check images and OCR processing results). In addition, large training sets of the other customer's historical information may be used to normalize prediction data (e.g., not skewed by a single or few occurrences of a data artifact). Thereafter, predictive ML model(s) may assess a specific deposit check image against the trained predictive model to predict whether image quality is sufficient to complete OCR processing. In some embodiments, the predictive ML model(s) may be continuously updated as new financial transactions occur.

In some embodiment, a ML engine may continuously change weighting of model inputs to increase accuracy of the predictive ML model(s). For example, weighting of specific data fields may be continuously modified in the model to trend towards greater accuracy, where accuracy is recognized by correct predictions of whether a deposit check image will be successfully processed via OCR. Conversely, term weighting that lowers accuracy may be lowered or eliminated.

In some embodiments, the ML engine may operate on, and machine learning models may be trained on, a mobile machine learning platform (e.g., mobile ML platform 310). In such embodiments, the machine learning models may be trained on a single customer's transactional information (e.g., previously submitted deposit check images and OCR processing results).

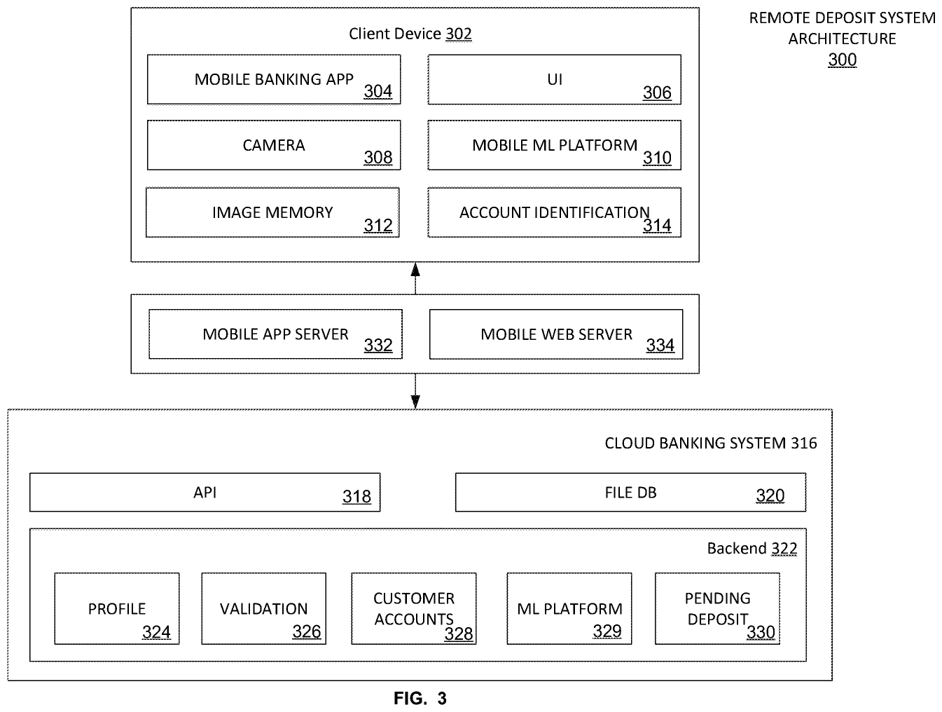

Various embodiments of this disclosure may be implemented using and/or may be part of a remote deposit system shown in FIGS. 3-5. It is noted, however, that this environment is provided solely for illustrative purposes, and is not limiting. Embodiments of this disclosure may be implemented using and/or may be part of environments different from and/or in addition to the remote deposit system, as will be appreciated by persons skilled in the relevant art(s) based on the teachings contained herein.

Variations of the devices disclosed herein are contemplated. For example, in a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

An example of the remote deposit system shall now be described.

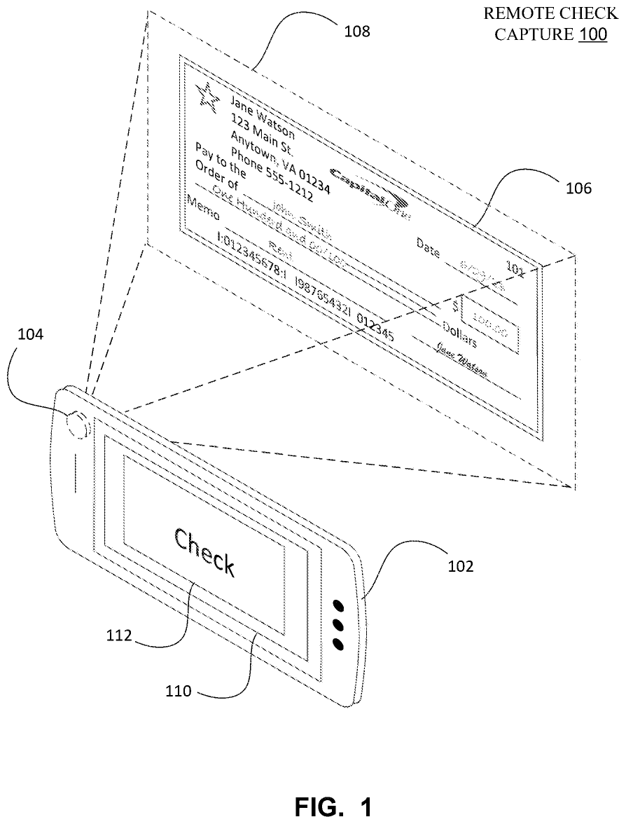

FIG. 1 illustrates an example remote check capture 100, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106 may be a personal check, paycheck, or government check, to name a few. In some embodiments, a customer may initiate a remote deposit check capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer may select a customer account at the bank account (e.g., checking or savings) into which the funds specified by the check are to be deposited. Content associated with the document may include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer may login to their mobile banking app, select the account they want to deposit a check into, then select, for example, a “deposit check” option that will activate their mobile device's camera 104 (e.g., activate the camera). One skilled in the art would understand that variations of this approach or functionally equivalent alternative approaches may be substituted to initiate a mobile deposit.

Using the camera 104 function on the mobile computing device 102, the customer may capture live imagery from a field of view 108 that includes at least a portion of one side of a check 106. Typically, the camera's field of view 108 will include at least the perimeter of the check 106. However, any camera position that generates in-focus check imagery 112 of the various data fields located on a check may be considered. Resolution, distance, alignment, and lighting parameters may require movement of the mobile device until a proper view of a complete check, in-focus, has occurred. An application running on the mobile computer device may offer suggestions or technical assistance to guide a proper framing of a check within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera may be remote to the mobile computing device 102. In an alternative embodiment, the remote deposit may be implemented on a desktop computing device with an accompanying digital camera.

Sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Hold the camera still,” “Once you've viewed a clear image of the front of the check, repeat the process on the back of the check,” “Do you accept the funds availability schedule?” “Swipe the Slide to Deposit button to submit the deposit,” “Your deposit request may have gone through, but it's still a good idea to hold on to your check for a few days,” “Keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

In a non-limiting example, live streamed image data captured using camera 104 may be assembled into one or more frames of image content. In some embodiments, a data signal from a camera sensor (e.g., CCD) may notify the banking app when an entire sensor has been read out as streamed data. In this approach, the camera sensor may be cleared of electrons before a subsequent exposure to light and a next image frame is captured. This clearing function may be conveyed to the mobile banking app, and/or a ML framework operating on mobile computing device 102, to indicate that the Byte Array Output Stream object constitutes a complete frame of image data. In some embodiments, the images formed into a byte array may be first rectified to correct for distortions based on an angle of incidence, may be rotated to align the imagery, may be filtered to remove obstructions or reflections, and may be resized to correct for size distortions using known image processing techniques. In some embodiments, these corrections may be based on recognition of corners or borders of the check as a basis for image orientation and size, as is known in the art.

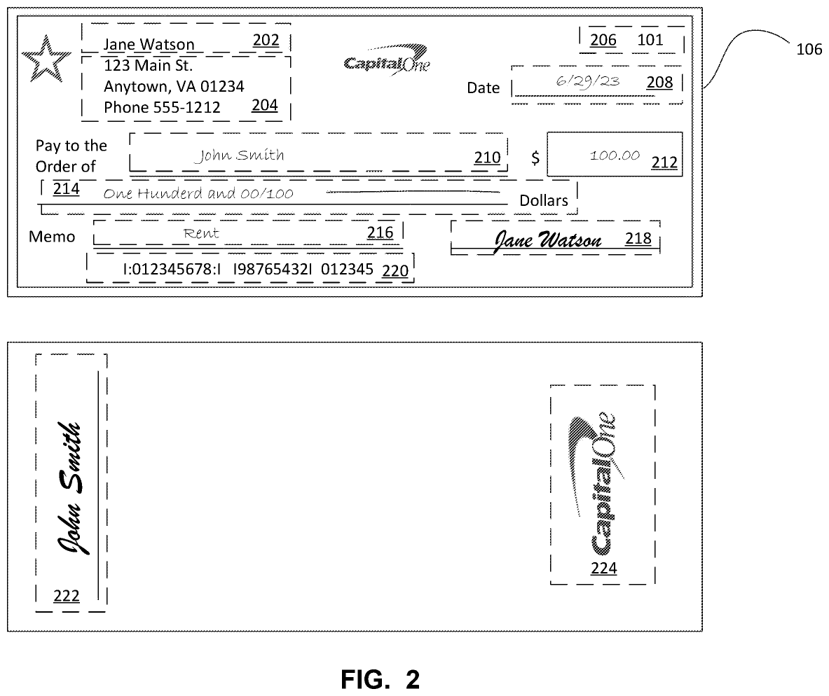

FIG. 2 illustrates example remote deposit OCR segmentation, according to some embodiments. Depending on check type, a check may have a fixed number of identifiable fields. For example, a standard personal check may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number, and finally the payer customer's signature 218. Back side identifiable fields may include, but are not limited to, payee signature 222 and security fields 224, such as a watermark.

While a number of fields have been described, it is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in the mobile banking app running on the mobile computing device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In some embodiments, successful processing via OCR may refer to correctly extracting from an image of sample check 106, via OCR processing, the fields required to complete a remote deposit of sample check 106. As a non-limiting example, successful processing of the image of sample check 106 may refer to correctly extracting at least MICR line 220, check number 206, payee field 210, and payment amount 212. Successfully processing of an image of sample check 106 need not include correctly extracting all identifiable fields from the image (such as all fields identified in FIG. 2). Various check processing platforms may be used in a remote deposit system, and these processing platforms may be implemented by a bank using third party software. Accordingly, various OCR processing systems and standards may be implemented depending on the remote deposit system, and their inner workings may not be readily known to the bank. As used herein, successful processing of an image via OCR may refer to cases in which an image submitted to a check image processing system, either implemented by a bank or a third party, is not returned for re-capture due to image quality deficiencies.

In some embodiments, OCR processing of an image of a check may include OCR processing performed at a backend system, for example, during a check image validation process. In such embodiments, the OCR processing may be implemented by a bank associated with a mobile banking app or may be implemented using third-party software hosted on a cloud banking system. OCR processing may include, but is not limited to, verification of data extracted from fields of the check based on a comparison with historical customer account data found in the customer's account (e.g., customer account 408) or the payer's account. In one non-limiting example, an address may be checked against the current address found in a data file of a customer account. In another non-limiting example, OCR processing may include checking a signature file within a customer account to verify the payee or payer signatures. It is also contemplated that a third party database may be checked for funds and signatures for checks from payers not associated with the customer's bank. Additional known OCR processing techniques may be substituted without departing from the scope of the technology described herein. Further, in some embodiments, OCR processing may be performed at mobile computing device 102. In some embodiments, the real-time image assessment described herein may be performed prior to any OCR processing, regardless of where it occurs, to avoid OCR processing costs if the image is not likely to successfully pass OCR processing.

FIG. 3 illustrates a remote deposit system architecture 300, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) may implement remote deposit processing for one or more financial instruments, such as checks. The client device 302 may be configured to communicate with a cloud banking system 316 to complete various phases of a remote deposit as will be discussed in greater detail hereafter.

In some embodiments, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 may communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 may be a computer program or software application designed to run on a mobile device such as a phone, tablet, or watch. However, in a desktop application, a desktop equivalent of the mobile banking app may be configured to run on desktop computers, and web applications, which run in mobile web browsers rather than directly on a mobile device. Applications or apps may be broadly classified into three types: native apps, hybrid, and web apps. Native applications may be designed specifically for a mobile operating system, such as iOS or Android. Web apps may be designed to be accessed through a web browser. Hybrid apps may be built using web technologies such as JavaScript, CSS, and HTML5 and function like web apps disguised in a native container.

Mobile banking application (app) 304, resident on client device 302, may include a computer instruction set to provide a secure mobile device banking session. The banking app may allow a customer to interact with their bank account information. For example, common functions include, but are not limited to, checking an account balance, transferring money between accounts, paying bills, making deposits, to name a few.

In some embodiments, mobile banking app 304 may include executable software that may communicate with various systems within client device 302 to provide ML functionality. For example, ML frameworks, for example, those provided by Core ML (iOS) or ML Kit (Android or iOS), may be implemented to establish communications between mobile banking app 304 and client device 302's ML capabilities. Mobile banking app 304 may include software instructions that interact with application programing interfaces (APIs), programs, libraries, and/or modules of an ML framework. When executed, instructions on mobile banking app 304 may cause ML models implemented by the ML framework and operating on client device 302 to receive and assess image data. As an example, mobile banking app 304 may execute an API call to a Core ML or ML Kit framework to run an image classification ML model and obtain an image classification and/or a confidence score associated with the classification (e.g., using the Vision framework supported by ML Core or the MLKitVision framework provided by ML Kit). The image classification ML model may receive image pixel data gathered via a camera of client device 302, along with image metadata in some embodiments. The image classification ML model may determine, based on the image pixel data and/or image metadata, whether one or more images should be classified as pass (will successfully pass OCR processing) or fail (will not pass OCR processing), and may provide its classification to mobile banking app 304. In some embodiments, a classification may be provided along with a confidence score indicating a likelihood the classification is correct. While image classification ML models are discussed, any predictive ML model may be implementing using Core ML and ML Kit frameworks.

While Core ML and ML Kit are discussed above as example ML frameworks/software development kits (SDKs), it should be understood that any suitable ML framework or SDK may be implemented. Various functions of the ML framework(s) implemented may be integrated with mobile banking app 304 or may operate on client device 302 but be separate from mobile banking app 304.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, may frame at least a portion of a check (e.g., identifiable fields on front or back of check) with a camera (e.g., field of view). In some embodiments, imagery may processed from live stream check imagery, as communicated from camera 308 over a period of time, until an image assessment has been completed.

In some embodiments, image data may be assembled into one or more frames of image content. In some embodiments, a data signal from a camera sensor (e.g., a charge-coupled device (CCD) or an active-pixel sensor (such as a complementary metal-oxide-semiconductor (CMOS) image sensor)) may notify mobile banking app 304 and/or mobile ML platform 310 when an entire sensor has been read out as streamed data. In this approach, the camera sensor may be cleared of electrons before a subsequent exposure to light and a next frame of an image is captured. This clearing function may be conveyed to mobile banking app 304 and/or mobile ML platform 310 to indicate that a Byte Array Output Stream object constitutes a complete frame of image data. In some embodiments, images formed into a byte array may be first rectified to correct for distortions based on an angle of incidence, may be rotated to align the imagery, may be filtered to remove obstructions or reflections, and/or may be resized to correct for size distortions using known image processing techniques. In some embodiments, these corrections may be based on recognition of corners or borders of the check as a basis for image orientation and size, as is known in the art.

In some embodiments, the camera imagery may be streamed as encoded text, such as a byte array. Alternatively, or in addition, one or more frames of the live imagery may be stored (e.g., at least temporarily) as images in computer memory. For example, one or more frames of live streamed check imagery from camera 308 may be stored locally in image memory 312, which may be, but is not limited to, a frame buffer, a video buffer, a streaming buffer, a virtual buffer, a hard drive, etc.

In some embodiments, image data may be stored in any known file format, for example, as a JPEG, PNG, TIFF, HEIC, or RAW file, or any other file type that supports metadata storage, before being provided to mobile ML platform 310. In some embodiments, metadata may be stored in a variety of formats within an image file, including one or more of EXIF, XMP, XML, 8BIM, IPTC, or ICC formats.

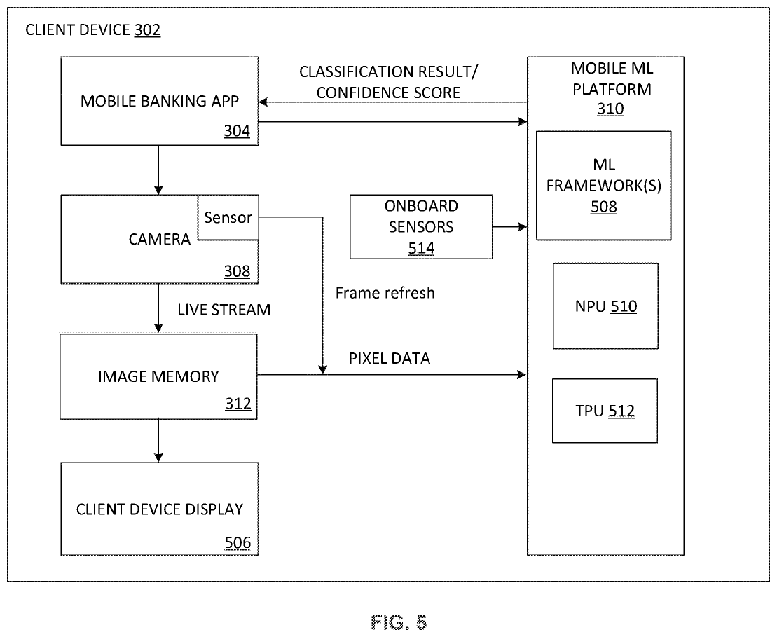

Mobile ML platform 310, which in some embodiments may be resident on the client device 302, may process one or more images (e.g., image frames extracted from a live image stream) received from camera 308 and/or image memory 312 to assess the likelihood the one or more images will be able to be successfully processed via OCR. In some embodiments, the image assessment process may be completed before finalization of a remote deposit operation. Accordingly, in such embodiments, an image acceptance status may be communicated to or determined by mobile banking app 304 for display on UI 306 before the one or more images are forwarded for further processing. In some embodiments, mobile ML platform 310 may include one or more ML frameworks which may implement predictive ML models (e.g., image classification ML models or regression ML models, etc.), as discussed in more detail with respect to FIG. 5.

Account identification 314 may use single or multiple level login data from mobile banking app 304 to initiate a remote deposit. Alternately, or in addition, in some embodiments, the extracted payee field 210 or the payee signature 222 may be used to provide additional authentication of the customer.

Mobile ML platform 310 (e.g., ML framework(s) operating on mobile ML platform 310) may communicate with a cloud banking system 316. For example, mobile ML platform 310 may communicate with cloud banking system 316 to receive trained ML models and/or provide data to cloud banking system 316 that may be used in continuous training of ML models deployed on client device 302 (e.g., a history of predictions, confidence scores, images, and/or image metadata). In some embodiments, such data may be communicated to file database (DB) 320 either through a mobile app server 332 or mobile web server 334 depending on the configuration of the client device (e.g., mobile or desktop). In some embodiments, such data may be communicated through the mobile banking app 304.

Alternatively, or in addition, in some embodiments, a thin client (not shown) resident on the client device 302 may implement ML models or ML model training as disclosed herein to provide local image assessment with assistance from cloud banking system 316. For example, a processor (e.g., CPU) may implement at least a portion of image assessment using resources stored on a remote server instead of a localized memory. The thin client may connect remotely to the server-based computing environment (e.g., cloud banking system 316) where applications, sensitive data, and memory may be stored.

Backend 322 may include one or more system servers processing banking deposit operations in a secure environment. These one or more system servers may operate to support client device 302. API 318 may be an intermediary software interface between mobile banking app 304, installed on client device 302, and one or more server systems, such as, but not limited to the backend 322, as well as third party servers (not shown). The API 318 may be available to be called by mobile clients through a server, such as a mobile edge server (not shown), within cloud banking system 316. File DB 320 may store files received from the client device 302 or generated as a result of processing a remote deposit.

Profile module 324 may retrieve customer profiles associated with the customer from a registry based on customer data extracted from front or back images of the financial instrument (e.g., via OCR processing). Customer profiles may be used to determine deposit limits, historical activity, security data, or other customer related data.

Validation module 326 may generate a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316, or third party systems or data. In some embodiments, OCR processing of an image of a financial instrument may be performed by validation module 326, which may return a result of image processing (pass/fail). In some embodiments, the result may be communicated to file DB 320 for storing with the image. In some embodiments, such as when training of an ML model is performed at client device 302, the result may be communicated to mobile banking app 304 via mobile app server 332 and/or API 318. The result may be used to refine ML image assessment models as disclosed herein.

Customer Accounts 328 (consistent with customer's accounts 408) may include, but is not limited to, a customer's financial banking information, such as individual, joint, or commercial account information, balances, loans, credit cards, account historical data, etc.

ML platform 329 may include a predictive ML model and/or a ML engine to train a predictive ML model used to assess images for fitness for OCR processing. For example, while the above disclosure has focused on a predictive ML model operating on client device 302, in some embodiments, the predictive ML model may operate on ML platform 329. In such embodiments, mobile banking app 304 may communicate an image, via mobile app server 332 and/or API 318, to the predictive ML model running on ML platform 329. The predictive ML model running on ML platform 329 may return an image classification result and/or associated confidence score to mobile banking app 304 in real time (e.g., before the image is forwarded for further processing). In some embodiments, “real-time” may refer to a time within a current customer transaction period before the payee customer submits a deposit request or immediately after in response to the payee customer submitting the deposit request.

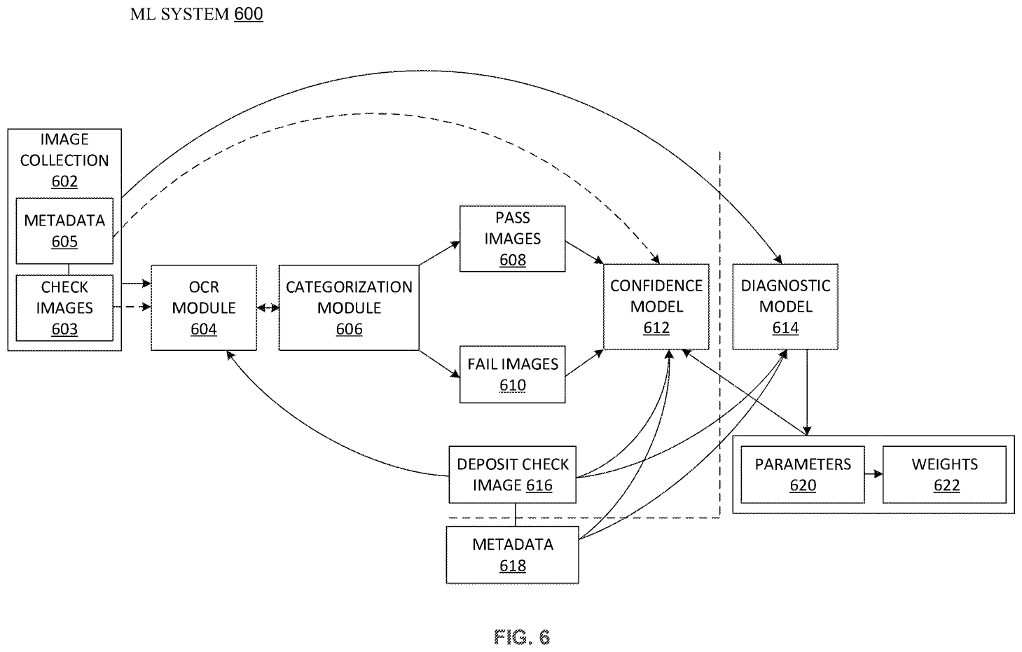

In some embodiments, ML platform 329 may be used to train a predictive ML model that may then be made available to mobile banking app 304 via mobile ML platform 310. In such embodiments, ML platform 329 may include or implement ML platforms such as Create ML (Mac), TensorFlow (Windows), or any suitable platform for training ML models. In some embodiments, ML platform 329 may host a diagnostic ML model, for example, a deep learning model, which may be used to assess the importance of various parameters in predicting whether an image will successfully pass OCR processing. In some embodiments, conclusions determined by the diagnostic algorithm regarding the parameters may be input into the predictive ML model to refine the predictive ML model. This process will be described in more detail with respect to FIG. 6.

This disclosure is not intended to limit ML platform 329 to only image assessment as it may also include or be used to train and/or implement remote deposit models, risk models, funding models, security models, dynamic funds availability models, etc.

In some embodiments, ML platform 329 may include software produced and implemented by the bank providing mobile banking app 304, and not third-party software. Alternatively, or in addition, ML platform 329 may include software produced and implemented by a third party.

In some embodiments, a funds availability schedule may be generated using an ML platform 329, as described in U.S. application Ser. No. 18/509,748, filed Nov. 15, 2023 and titled “DEPOSIT AVAILABILITY SCHEDULE,” the disclosure of which is incorporated by reference herein in its entirety. When a funds availability schedule is generated, it may be passed back to the client device 302 through API 318 where it may be formatted for communication and display on the client device 302. For example, the funds availability schedule may be communicated for display or rendering on the customer's device through the mobile banking app UI 306. In some embodiments, UI 306 may instantiate the funds availability schedule as images, graphics, audio, additional content, etc.

Pending deposit 330 may include a profile of a potential upcoming deposit(s) based on an acceptance by the customer through UI 306 of a deposit according to given terms. If the deposit is successful, the system may create a record for the transaction and this function may retrieve a product type associated with the account, retrieve data on customer interactions with UI 306, and create a pending check deposit activity.

One or more components of the remote deposit process described above may be implemented within the client device 302, third party platforms, the cloud-based banking system 316, or distributed across multiple computer-based systems.

In some embodiments, remote deposit system 300 may track customer behavior. For example, how many attempts did it take for a customer to acquire an image that passed real time image assessment? In some embodiments, the number of attempts, across one or multiple customers, may be used to adjust a threshold confidence a predictive ML model must reach in order for an image to be classified as “pass” (predicted to successfully pass OCR processing). A high number of attempts could indicate that the predictive ML model and/or mobile banking app 304 is being too strict (rejecting too many images). Accordingly, in some embodiments, the number of attempts may be fed to ML platform 329, where it may be parsed (e.g., via a trained ML model) to determine an optimized threshold confidence that reduces the number of attempts while still reducing the number of images that pass the real time image assessment but later fail OCR processing. In the process of calculating the optimized threshold confidence, reducing the number of attempts and reducing the number of images that pass real time image assessment but later fail OCR processing may be weighted differently. For example, reducing the number of images that pass real time image assessment but later fail OCR processing may be weighted more heavily, due to its greater impact on customer frustration levels as compared to reducing the number of real-time image retakes. In some embodiments, the optimized threshold confidence may be provided back to mobile banking app 304 and/or a predictive ML model operating on mobile ML platform 310 for use in classifying images.

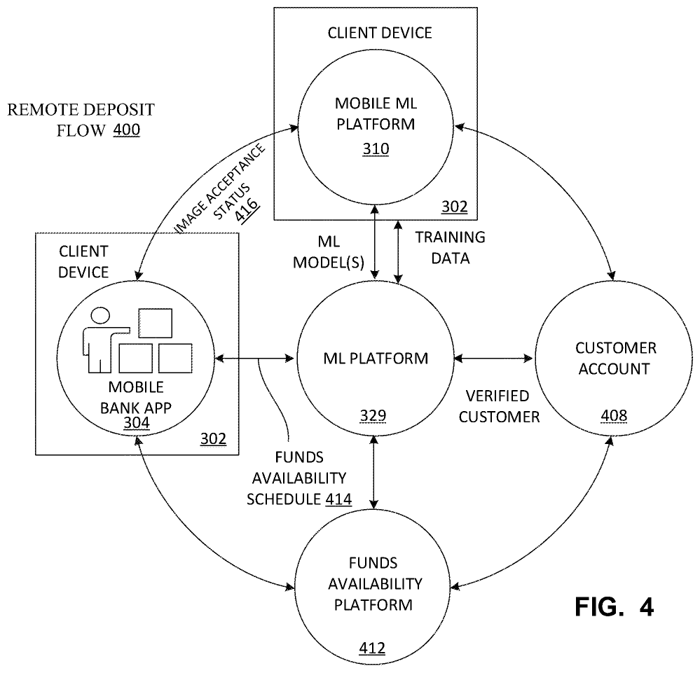

FIG. 4 illustrates an example flow diagram of a remote deposit system, according to some embodiments. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a bank customer using a client device 302 (e.g., mobile computing device 102), operating a mobile banking app 304, may frame at least a portion of a check within a field of view from an active camera (e.g., camera activated) of client device 302. As previously described, the imagery within the field of view may, in some embodiments, be configured as a live stream. In some embodiments, the camera imagery may be streamed as encoded text, such as a byte array (e.g., as a Byte Array Output Stream object). In some embodiments, this live stream of image data may be processed, without requiring image storage, using a client device resident mobile ML platform 310 (e.g., including ML framework(s)). In alternative embodiments, one or more frames of the camera imagery may be at least temporarily stored and subsequently processed by mobile ML platform 310. In some embodiments, a blended image as disclosed in U.S. application Ser. No. 18/503,787, filed Nov. 7, 2023 and titled “BURST IMAGE CAPTURE,” the disclosure of which is incorporated by reference herein in its entirety, may be captured and subsequently processed by mobile ML platform 310.

An ML model implemented by mobile ML platform 310 may provide an image assessment and image acceptance status 416 in real time (e.g., within a current customer transaction period before the payee customer submits a deposit request or immediately after in response to the payee customer submitting the deposit request, for example, before the image is uploaded to a backend server and/or forwarded for OCR processing). In some embodiments, image acceptance status 416 can include an image acceptance prediction, or a prediction of whether one or more image frames will be successfully processed via OCR. In some embodiments, such as when the one or more image frames are stored and subsequently processed by mobile ML platform 310, the image acceptance status 416 may be used to trigger a request for the customer to capture another image (e.g., when the one or more frames are predicted to not be acceptable). In some embodiments, such as when the one or more image frames are streamed and immediately processed by mobile ML platform 310, without storing an image frame, the image acceptance status 416 may be used to trigger automatic image capture and at least temporary storage (e.g., when a predicted acceptable frame has been identified).

Sample image acceptance statuses 416 may include, but are not limited to, “Your image is not clear. Please retake the image,” “Your image is not clear. Please retake the image and hold the camera still while photographing,” and “Your image is not clear. Please hold the camera farther from the check and retake the image.” These statuses are provided as sample statuses or instructions but any statuses or instructions that guide the customer through an image capture session may be included. UI 306 may instantiate an image acceptance status 416 as images, graphics, audio, additional content, etc.

In one technical improvement over current processing systems, the image acceptance status 416 status may be provided mid-stream, for example, prior to upload of an image to a backend server and/or OCR processing. In this approach, the customer may terminate the process prior to completion if they are dissatisfied with the image acceptance status 416, or may retake an image.

In some embodiments, image acceptance status 416 may include instructions that may be based on a diagnostic of the image run by a diagnostic ML model (e.g., diagnostic model 614 discussed with respect to FIG. 6). In some embodiments, the diagnostic model may be a deep learning model configured to determine one or more factors (e.g., device movement, distance from the device to the check, camera settings) that caused the image to fail the initial image assessment. In such embodiments, image acceptance status 416 may instruct a customer to modify a condition of image capture to correct the one or more factors identified by the diagnostic model (e.g., hold device steady, move device farther from the check, or adjust a camera setting).

ML platform 329 and mobile ML platform 310 may be in communication for the training and refinement of ML models implemented by mobile ML platform 310. For example, ML algorithms may be trained on ML platform 329 using training data, which may include images captured by client device 302. A resulting ML model may be provided to client device 302. Additionally, the ML model may be continuously refined. In some embodiments, the ML model may be refined on ML platform 329 based on training data that may be provided to ML platform 329 by client device 302. The training data may include images and associated data. In some embodiments, the associated data transmitted by client device 302 may include results of real time ML image assessment performed at client device 302 and/or image metadata from the time of image capture (e.g., image metadata such as metadata 605/metadata 618 described with respect to FIG. 6). In such embodiments, items of the associated data may be associated with individual images. In some embodiments, an ML model refined at ML platform 329 may be provided to client device 302 and may be accessible in new versions of mobile banking app 304 (i.e., the refined model may be provided as part of a software update).

In some embodiments, an ML model may be refined on client device 302. For example, in the case of a predictive ML model operating on client device 302, refining the model may include determining OCR processing of an image has failed even though the image was classified as “pass” based on the results of the predictive ML model's analysis. This determination may be performed on cloud banking system 316, for example, by validation module 326. In such cases, the predictive ML model may have provided a prediction that the image would pass OCR processing, or a confidence score that met a threshold for such a prediction, and based on the predictive ML model's prediction, the image may have been forwarded for further processing. But the image may have been rejected due to an inability to perform OCR processing on the image. In such cases, refining the predictive ML model may include providing the determination that the image has failed OCR processing to mobile banking app 304 (e.g., via mobile app server 332 and/or API 318). The determination may be provided with the rejected image or with an identifier for locating the rejected image within image memory 312. Accordingly, mobile banking app 304 may receive or create a label associated with the failed image, based on the determination. Mobile banking app 304 may then provide the labeled, rejected image (with or without image metadata) to the predictive ML model for further training on an ML framework of mobile ML platform 310. In some embodiments, cloud banking system 316 and mobile banking app 304 may do the same for an image that has passed OCR processing to facilitate continuous training of the predictive ML model.

In embodiments in which the predictive ML model may be trained and/or refined at client device 302, the predictive ML model may be a file (e.g., an .mlmodel file for Core ML) that is configured to allow updating (e.g., the model may be marked as updatable and/or has training inputs). In the case of a neural network, the file may be made updateable by marking certain layers as updatable, including one or more loss functions (e.g., cross-entropy or mean squared error (MSE)), including an optimizer (stochastic gradient descent (SGD) or Adam), and/or including default values for the hyperparameters (e.g., the number of epochs).

While the above process has been described for refining the predictive ML model on client device 302, in some embodiments, the same or a similar process may be performed on ML platform 329. In some embodiments, the predictive ML model may be trained and/or refined using distributed training, leveraging the interactions of multiple client devices 302 and cloud banking system 316, where each client device 302 constitutes a node in the distributed training network. In such embodiments, the distributed training may implement a data parallelism approach.

Client device 302 may obtain and transmit check images, including front and back images of a check, captured using camera 308. The check images may then be stored in the customer account 408 for later use if necessary. In some embodiments, the check images may be stored (e.g., in file DB 320) with associated data including image metadata, results of real time ML image assessment, final OCR processing results, or any combination thereof. The check images and associated data may be used to refine one or more ML models operating within remote deposit flow 400, as described above.

The customer account 408, for purposes of description, may be the payee's account, the payer's account or both. For example, a payee's account historical information may be used to calculate a payee's funds availability schedule 414, while a payer's account may be checked for funds to cover the check amount.

Data fields extracted in an OCR operation may be communicated to a funds availability platform 412. For example, customer data (e.g., name, address, account number, bank information (e.g., routing information), check number, check amount (e.g., funding amount needed), authorization and anti-fraud information (e.g., signature verifications, watermark or other check security imagery), etc. may be communicated to funds availability platform 412.

ML platform 329, in communication with funds availability platform 412, may compute a funds availability schedule 414 based on one or more of the received data fields, customer history received from the customer's account 408, bank funding policies, legal requirements (e.g., state or federally mandated limits and reporting requirements, etc.), or typical schedules stored within funds availability platform 412, to name a few. ML platform 329 may return a fixed or dynamically modifiable funds availability schedule 414 to the UI 306 on the client device 302. ML platform 329 may perform any of the above functions in line with the disclosure of U.S. application Ser. No. 18/509,748, filed Nov. 15, 2023 and titled “DEPOSIT AVAILABILITY SCHEDULE,” which is incorporated by reference herein in its entirety.

In a non-limiting example, OCR of a check image may identify the MICR data as a verified data field that may be used to access a customer's account 408. This access may allow the bank identified in the MICR to provide a history of the customer's account 408 to the ML platform 329, via any channel of remote deposit system architecture 300. Early access to the customer's account may also provide a verified customer for security purposes to eliminate or reduce fraud in the remote deposit process.

ML platform 329 may provide funds availability schedule 414, which may be communicated and rendered on the client device 302 within one or more user interfaces (UIs) of the customer device's mobile banking app 304. The rendering may include imagery, text, or a link to additional content. The UI may instantiate the remote funds availability schedule 414 as images, graphics, audio, etc. In some embodiments, an estimated date of deposit may be communicated. In some embodiments, funds availability schedule 414 and image acceptance status 416 may be combined and communicated simultaneously. In some instances, funds availability schedule 414 may include a notice of failed processing (e.g., OCR processing of a deposit check image has failed).

Alternatively, or in addition, one or more components of the remote deposit flow 400 may be implemented within the customer device, third party platforms, and a cloud-based system or distributed across multiple computer-based systems.

FIG. 5 illustrates an example diagram of a client device 302, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In some embodiments, the mobile banking app 304 may be opened on the client device 302 and the deposit check function selected to initiate a remote deposit process. A camera may be activated (e.g., camera 308) to communicate a live stream of imagery (e.g., frames of video) from a field of view of the camera 308. A camera may output, for display at client display device 506, a frame (e.g., an image frame or a frame of a video, for example) depicting one or more real-world objects that are viewable by camera 308. For instance, an image may depict an entire group of checks in a field of view of camera 308, or the image may depict one or more individual objects within the group. In some embodiments, the image of decodable check indicia may be provided by a raw image byte stream or by a byte array, a compressed image byte stream or byte array, and/or a partial compressed image byte stream or byte array.

At this point, the customer of the client device 302 may view the live stream of imagery on a UI of the client device display 506, after buffering in image memory 312, which may include a buffer (e.g., frame buffer, video buffer, etc.). In some embodiments, the live stream may communicated to mobile ML platform 310 as a raw image live stream. In some embodiments, the raw image live stream may first be converted to a byte array and then communicated to mobile ML platform 310 (buffered or not buffered, or after being stored in permanent memory). The data embedded in the byte stream or byte array may then extracted by a predictive ML model implemented by ML framework(s) 508 of mobile ML platform 310, processed, and used to issue a prediction (e.g., a classification result and/or confidence score). This prediction may be transmitted to mobile banking app 304 periodically (e.g., after an image has been provided to the predictive ML model) or continuously (e.g., as frames in a continuous image stream are being assessed). In embodiments in which a live stream is provided to the predictive ML model, the prediction output by the predictive ML model may be used to trigger automatic image capture (e.g., selecting and storing and/or transmitting an image frame for further processing).

In some embodiments, the front side imagery may be processed followed by the back side imagery. Alternatively, or in combination, the front side and back side imagery may be processed together or in parallel.

As shown in FIG. 5, mobile ML platform 310 may include ML framework(s) 508, neural processing unit (NPU) 510, and/or tensor processing unit (TPU) 512. In some embodiments, mobile ML platform 310 may include both neural processing unit 510 and tensor processing unit 512. In alternative embodiments, mobile ML platform 310 may include either neural processing unit 510 or tensor processing unit 512.

Traditionally, machine learning models may be implemented on a mobile device using the processing capabilities of the mobile device's CPU and/or GPU. However, a NPU 510 or TPU 512 may be optimized for matrix operations, such as matrix multiplication and convolutions, which constitute some of the most common and computationally intensive mathematical operations performed in machine learning. Accordingly, NPUs and TPUs may be optimized for machine learning tasks, and in particular implementing artificial neural networks and deep learning.

ML framework(s) 508 may include programing interfaces (APIs), programs, libraries, and/or modules that operate on client device 302's CPU, GPU, NPU 510, and/or TPU 512. In some embodiments, ML framework(s) 508 may implement ML models that have been trained on ML platform 329 and downloaded onto client device 302 as part of mobile banking app 304's installation package. In alternative embodiments, ML framework(s) 508 may implement ML models that have been trained using ML framework(s) 508 on client device 302. In some embodiments, ML framework(s) 508 may be configured to implement computer vision ML models, such as computer vision-based predictive ML models (e.g., image classification ML models, computer vision-based regression models, etc.). As a non-limiting example, an ML framework 508 may be Apple's Vision framework, supported by Core ML.

In some embodiments, an image classification ML model operating on ML framework(s) 508 may be configured, via training at cloud banking system 316 and/or client device 302, to categorize an image provided to an image classification model as either pass (predicted to pass OCR processing) or fail (predicted to fail OCR processing). In some embodiments, the image classification ML model may further be configured to provide a confidence score associated with one or more of the pass/fail predictions. For example, in some embodiments, the image classification ML model may be configured to provide both a confidence score (e.g., a percentage) predicting whether the image will pass and a confidence score (e.g., a percentage) predicting whether the image will fail. For example, in such embodiments, the image classification ML may indicate that an image is 72.5% likely to pass, and 27.5% likely to fail. In some embodiments, the image classification ML model may be configured to provide only a confidence score predicting whether the image will pass. In some embodiments, the image classification ML model may be configured to provide only a confidence score predicting whether the image will fail. In some embodiments, the image classification ML model may be configured to not provide a confidence score, but only a binary determination (e.g., pass/fail).

In some embodiments, after providing a check image to a predictive ML model (e.g., an image classification ML model), mobile banking app 304 (or another component within remote deposit system architecture 300) may receive a prediction from the predictive ML model regarding a likelihood the check image will be successfully processed via OCR to obtain deposit data. For example, mobile banking app 304 (or the other component) may receive from the predictive ML model a confidence score indicating a likelihood the check image will be successfully processed via OCR to obtain deposit data. The confidence score may be a confidence score predicting whether the image will pass or a confidence score predicting whether the image will fail, as described above. In some embodiments, a predetermined threshold may be set within mobile banking app 304. In response to the confidence score meeting the predetermined threshold, mobile banking app 304 may forward the check image for OCR processing (e.g., at cloud banking system 316 or a third party server). In the case of the confidence score being a confidence score predicting whether the image will pass, meeting the predetermined threshold may include equaling or exceeding the predetermined threshold. In the case of the confidence score being a confidence score predicting whether the image will fail, meeting the predetermined threshold may include equaling or being less than the predetermined threshold.

In some embodiments, the predetermined threshold may be set within the predictive ML model, rather than within mobile banking app 304. In such embodiments, the predictive ML model may provide a classification result (e.g., pass/fail determination) based on the confidence score meeting the predetermined threshold. In such embodiments, mobile banking app 304 may forward the check image for OCR processing in response to the classification result indicating “pass.”

While mobile banking app 304 is described above as receiving confidence scores and performing actions, other components within remote deposit system architecture 300 (e.g., programs or APIs operating on cloud banking system 316) may perform the operations described above, particularly if the predictive ML model is implemented off of client device 302.

Whether the predetermined threshold is set within mobile banking app 304 (or another component of remote deposit system architecture 300) or the predictive ML model, the predetermined threshold may be set manually (i.e., by direct coding) in response to one or more factors or automatically in response to the one or more factors. The factors may include a number of images used so far to train the predictive ML model (more images may lead to more accurate predictions); a successful prediction rate (i.e., a percentage of images that have been predicted to pass OCR processing but later fail); a number or average number of attempts, across one or multiple customers, that it takes for a customer to acquire an image that meets a predetermined threshold that is implemented on a customer device; or any combination thereof. In embodiments in which the predetermined threshold is set automatically, mobile banking app 304 or the trained predictive ML model may include a program that receives one or more of the above factors and returns the predetermined threshold.

In some embodiments, when the confidence score used to determine whether to forward an image for OCR processing and remote deposit is a confidence score predicting whether the image will pass, the predetermined threshold may be from 50% to 100%, including subranges. For example, in some embodiments, the predetermined threshold may be from 55% to 100%, from 60% to 100%, from 65% to 100%, from 70% to 100%, from 75% to 100%, from 80% to 100%, from 85% to 100%, from 90% to 100%, or from 95% to 100%. In some embodiments, when the confidence score is a confidence score predicting whether the image will fail, the predetermined threshold may be from 0% to 50%, including subranges. For example, in some embodiments, the predetermined threshold may be from 0% to 45%, from 0% to 40%, from 0% to 35%, from 0% to 30%, from 0% to 25%, from 0% to 20%, from 0% to 15%, from 0% to 10%, or from 0% to 5%.

While confidence scores that are percentages are discussed herein, other types of confidence scores are contemplated, such that a confidence score is not limited to a percentage. Confidence scores may be numbers on a scale, e.g., 0 to 1, 0 to 10, etc.

As shown in FIG. 5, client device 302 may include onboard sensors 514. In some embodiments, onboard sensors 514 may include a gyroscope, an accelerometer, a magnetometer, time-of-flight (ToF) sensor, structured light illumination (SLI) sensor, light detection and ranging (LiDAR) sensor, or any combination thereof. In some embodiments, onboard sensors 514 may provide data that may be used, along with pixel data from camera 308, to perform a real time image usability assessment. In some embodiments, onboard sensors 514 may include an inertial measurement unit (IMU), which may include three accelerometers, three gyroscopes, and three magnetometers.

In some embodiments, a predictive ML model implemented by ML framework(s) 508 may receive data determined using one or more onboard sensors 514 and may use the data in determining the likelihood a check image associated with the data will be successfully processed via OCR to obtain deposit data. For example, in some embodiments, an accelerometer of onboard sensor 514 may determine an acceleration value at the time the check image is captured. The acceleration value may be stored with the check image as metadata associated with the check image. In some embodiments, predictive ML model may determine the likelihood the check image will be successfully processed via OCR based on the check image and the acceleration data. In some embodiments, the same process may be implemented with gyroscope data (e.g., angular velocity), with or without acceleration data determined using an accelerometer. In embodiments in which onboard sensor data is used, the predictive ML model may be trained using such onboard sensor data, by providing the onboard sensor data as image metadata of training images, as will be described in more detail below with respect to FIG. 6.

The technical solution disclosed above allows a real time image usability assessment, without first requiring the upload and/or OCR processing of an image, and communication thereof. This solution accelerates the remote check deposit process and allows mid-stream alterations or improvements, for example, real time image quality guidance or customer inputs (e.g., mid-stream cancelation or image re-capture).

FIG. 6 illustrates a machine learning (ML) system 600, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art.

ML system 600 illustrates the process of training, implementing, and optionally refining a confidence model 612. In some embodiments, confidence model 612 may be a trained predictive ML model such as those described above. In some embodiments, ML system 600 may operate partially or entirely within remote deposit system architecture 300. Alternatively or additionally, in some embodiments, ML system 600 may operate partially or entirely at third party servers. In some embodiments, OCR module 604 and/or categorization module 606 may be accessible though API calls within remote deposit system architecture 300. In such embodiments, OCR module 604 and/or categorization module 606 may include third party software implemented within cloud banking system 316 or at a third party server.

As shown in FIG. 6, ML system 600 may include an image collection 602. In some embodiments, image collection 602 may include images captured using a client device 302 and submitted by one or more customers of mobile banking app 304. Image collection 602 may include images depicting a financial instrument (e.g., sample check 106), such as check images 603. In some embodiments, image collection 602 may include check images 603 gathered from third party sources (e.g., internet archives), with or without check images 603 submitted by one or more customers of mobile banking app 304. In some embodiments, a check image 603 may depict a front side of a check. In some embodiments, a check image 603 may depict both a front and a back side of a check (e.g., be a merged picture). In some embodiments, a check image 603 may depict a back side of a check. In some embodiments, check images 603 may include pixel data. In some embodiments, the pixel data may be RGB data, CMYK data, YCbCr data, HSV data, HSL data, hex codes, or any other pixel data that may be processed and analyzed by an ML model.

In some embodiments, image collection 602 may also include metadata 605. One or more items of metadata 605 may be associated with each of check images 603. In some embodiments, metadata 605 may be linked to a check image 603. For example, in some embodiments, items of metadata 605 may be stored with pixel data of check image 603 in a single image file, for example, a JPEG, PNG, TIFF, HEIC, or RAW file, or any other file type that supports metadata storage. In some embodiments, metadata 605 may be stored in a variety of formats within the image file, including one or more of EXIF, XMP, XML, 8BIM, IPTC, or ICC formats.

In some embodiments, metadata 605 may include a timestamp (e.g., date/time, and optionally sub-second time) that may be used to identify check image 603. Additionally or alternatively, in some embodiments, metadata 605 may include values for parameters that are associated, alone or in combination with other parameters, with image blurriness. For example, in some embodiments, metadata 605 may include values for shutter speed, exposure time, image resolution, focal plane resolution, distance from the camera to the check in check image 603, focal length, f-number, aperture (e.g., f-stop), metering mode, exposure mode, exposure program, ISO number, autofocus mode, sharpness, contrast, or any combination thereof. Additionally or alternatively, in some embodiments, metadata 605 may include one or more values for brightness of an image and/or brightness of one or more portions of an image (along with data indicating the location(s) of the portion(s) in the image). Any one or combination of the above values may be associated with a particular check image 603. Additionally or alternatively to values for one or more of the above parameters, in some embodiments, metadata 605 may include movement data from the time of capture of check image 603, as described below. As a non-limiting example combination, metadata 605 may include values for shutter speed and/or exposure time, distance, and movement data, along with values for none or a subset of the other parameters indicated above (e.g., focal length). This combination may be useful since distance and shutter speed may influence the impact of movement on blurriness (i.e., moving at a same velocity while farther away will cause an object to move fewer pixels within an image, causing less blur; likewise, moving at a same velocity with a faster shutter speed will cause less blur). Similarly, metadata 605 may include values for shutter speed and movement data, along with values for none or a subset of the other parameters indicated above. In some embodiments, metadata 605 may include ratios of two or more parameters, for example, the ratio of an item of movement data over shutter speed. The parameters identified above may be associated with blurriness individually (e.g., resolution) and in combination with other parameters (e.g., shutter speed and movement data together).

In some embodiments, distance from the camera to the check in check image 603 may be determined using multiple lenses and/or cameras on client device 302, data from each of which may be compared to obtain depth data. For example, the difference in location of an object within two images captured using two lenses on the same device may be used to calculate distance to the object from the lenses.

In some embodiments, the movement data may include one or more acceleration values from the time of capture of an associated check image 603, the one or more acceleration values determined using an accelerometer (e.g., of onboard sensors 514). In some embodiments, the one or more acceleration values may include a total linear acceleration magnitude. Additionally or alternatively, in some embodiments, the one or more acceleration values may include directional information. For example, in some embodiments, the one or more acceleration values may include linear acceleration magnitudes along one or more axes (e.g., x, y, and z axes defined with respect to the camera or an external coordinate system); or, in some embodiments, the one or more acceleration values may include a total linear acceleration magnitude and a linear acceleration direction, defined with respect to the camera or an external coordinate system, for example, using polar coordinates.

Additionally or alternatively, in some embodiments, the movement data included in metadata 605 may include one or more angular velocity values from the time of capture of an associated check image 603, the one or more angular velocity values determined using a gyroscope (e.g., of onboard sensors 514). In some embodiments, the one or more angular velocity values may include a total angular velocity magnitude. Additionally or alternatively, in some embodiments, the one or more angular velocity values may include directional information. For example, in some embodiments, the one or more angular velocity values may include angular velocity magnitudes around one or more axes (e.g., x, y, and z axes defined with respect to the camera or an external coordinate system); or, in some embodiments, the one or more angular velocity values may include a total angular velocity magnitude and an angular velocity direction, defined with respect to the camera or an external coordinate system, for example, using polar coordinates and the right hand rule.

Additionally or alternatively, in some embodiments, the movement data may include one or more acceleration values and/or one or more angular velocity values determined using a magnetometer or other sensor of onboard sensors 514. Additionally or alternatively, in some embodiments, the movement data may include one or more linear velocity values determined using an accelerometer (and integrating gathered data), magnetometer, and/or other sensor of onboard sensors 514. In some embodiments, the movement data may include linear and/or angular velocity and/or acceleration values determined from data gathered by a time-of-flight (ToF) sensor, structured light illumination (SLI) sensor, or light detection and ranging (LiDAR) sensor.

Accordingly, metadata 605 may include movement data that is cumulative (e.g., a total linear acceleration magnitude and/or total linear acceleration direction) or component based (e.g., linear acceleration along x, y, and z axes). In some embodiments, metadata 605 may include movement data that is cumulative and movement data that is component based. Accordingly, in some embodiments, a confidence model 612 which has been trained using metadata 605 may determine a likelihood a deposit check image 616 will be successfully processed via OCR based on individual component movement data, as described in more detail below.

In some embodiments, movement data may be added to image metadata (e.g., metadata 605 or metadata 618) by mobile banking app 304 prior to mobile banking app 304 transferring a check image 603 or deposit check image 616 to confidence model 612. For example, in some embodiments, mobile banking app may edit an EXIF file or other metadata file associated with the check image 603 or deposit check image 616. In some embodiments, the movement data may be included in metadata 605 or metadata 618 (e.g., metadata of an image captured by a camera 308 of a client device 302) automatically by the manufacturer of the client device 302.

While various types of metadata 605 have been described above, the examples provided are not limiting and it should be understood that any type of metadata 605 may be associated with a check image 603 for training confidence model 612. Training confidence model 612 using both pixel data and metadata 605 may increase the accuracy and efficiency of the resulting confidence model 612, as various characteristics of a deposit check image 616 (e.g., brightness, contrast, and/or movement data, etc.) may be compared to corresponding characteristics of categorized training images to determine the likelihood of successful OCR processing of the deposit check image 616.

As shown in FIG. 6, ML system 600 may also include OCR module 604. In some embodiments, OCR module 604 may operate at cloud banking system 316 (and may include software developed by the bank hosting mobile banking app 304 or may include third party software) or may operate at a third party server. OCR module 604 may extract, via OCR processing, data from check images 603. In some embodiments, OCR module 604 may operate as part of the standard remote deposit process. For example, in some embodiments, each of check images 603 may have been submitted by a customer (either the same or different customers) and may have undergone OCR processing as part of an attempt to deposit the check depicted in each of check images 603. In alternative embodiments, OCR module 604 may operate separately from the standard remote deposit process. For example, in some embodiments, OCR module 604 may operate to extract data from check images 603 that have not been submitted for remote deposit or will be separately processed via OCR by another system as part of the remote deposit process.

In some embodiments, OCR module 604 may include an OCR ML model such as that described in U.S. application Ser. No. 18/503,778, filed Nov. 7, 2023 and titled “ACTIVE OCR,” the disclosure of which is incorporated by reference herein in its entirety.

OCR module 604 may be configured to extract the requisite data for completing a remote deposit process. In some embodiments, the requisite data may include a MICR line extracted from a check image 603 (e.g., MICR line 220), a check number extracted from a check image 603 (e.g., check number 206), a payee field extracted from a check image 603 (e.g., payee field 210), and a payment amount extracted from a check image 603 (e.g., payment amount 212). While these fields are identified, the requisite data may include any fields identified as required for remote check deposit by the bank or third party that provides OCR module 604. In some embodiments, whether the requisite data is extracted may be determined based on a confidence score associated with an extracted field, word, or character. In such embodiments, the confidence score may indicate a likelihood that the field, word, or character was correctly extracted, and may be determined by OCR module 604 according to any known methods for determining character-level, word-level, and/or field-level OCR confidence scores.

In some embodiments, a categorization module 606 may receive one or more fields, words, and/or characters OCR module 604 attempts to extract and/or one or more confidence scores associated with the one or more fields, words, and/or characters. In some embodiments, categorization module 606 may determine, based on the one or more fields and/or the one or more confidence scores, whether a check image 603 passes OCR processing. In some embodiments, categorization module 606 module may operate at cloud banking system 316 (and may include software developed by the bank hosting mobile banking app 304 or may include third party software) or may operate at a third party server. Additionally or alternatively, in some embodiments, categorization module 606 may operate at client device 302 (for example, as part of mobile banking app 304). In some embodiments in which on-device training of confidence model 612 is implemented, categorization module 606 may operate at least partially on client device 302 to label check images, though categorization module 606 may label check images at any location within remote deposit system architecture 300 and provide the labels to mobile banking app 304 for on-device training. In some embodiments, categorization module 606 may operate partially at a third party server, where the determination of whether a check image 603 passes OCR processing is performed, and partially within cloud banking system 316, where labeling is performed. In some embodiments, categorization module 606 may simply determine whether a check image 603 passes OCR processing, and a human programmer may label the check image 603 accordingly.

In some embodiments, categorization module 606 may be integrated with OCR module 604 and may be implemented as part of the standard remote deposit process. For example, in such embodiments, each of check images 603 may have been submitted by a customer (either the same or different customer) and may have undergone OCR processing, with a subsequent determination of whether the OCR processing was successful, as part of an attempt to deposit the check depicted in each of check images 603. In alternative embodiments, categorization module 606 may operate separately from the standard remote deposit process. For example, in some embodiments, categorization module 606 may operate to determine whether check images 603 pass OCR processing, even if the check images 603 have not been submitted for remote deposit or will be separately processed via OCR and categorized by another system as part of the standard remote deposit process.

In some embodiments, categorization module 606 determining whether a check image 603 passes OCR processing may include categorization module 606 comparing an extracted field to historical data. For example, categorization module 606 may compare an extracted payee field to a payee customer name stored in customer account 408.

Additionally or alternatively, in some embodiments, categorization module 606 determining whether a check image 603 passes OCR processing may include categorization module 606 determining whether a confidence score associated with an extracted field, word, and/or character meets a predetermined threshold. For example, if OCR module 604 reaches a determination of 85% surety of a correct data field extraction, categorization module 606 may determine that the OCR process for that field is successful. While 85% surety was provided as an example, a skilled artisan would appreciate that any percentage, such as 51%, 55%, 60%, 75%, 90%, 95%, to name a few, may be chosen as the threshold for determining that the OCR process for that field is successful.

Categorization module 606 generate and associate categorization data with images. For example, categorization module 606 may categorize images that it determines have passed OCR processing as pass images 608. Likewise, categorization module 606 may categorize images that it determines have failed OCR processing as fail images 610. In some embodiments, categorization module 606 may label pass images 608 and fail images 610. For example, categorization module 606 may add a tag to each image of pass images 608 indicating the image has passed OCR processing. Likewise, categorization module 606 may add a tag to each image of fail images 610 indicating the image has failed OCR processing. In alternative embodiments, a programmer may manually label pass images 608 and fail images 610, based on determinations made by categorization module 606 and/or confidence scores associated with field, word, and/or character extractions determined by OCR module 604. In either case, the labels (e.g., tags) may be provided with pass images 608 and fail images 610 to an untrained or partially trained confidence model 612 to further train confidence model 612.

An “untrained or partially trained” model may refer to a model that is either an untrained ML algorithm or an ML algorithm that has received some training. Any level of training may be considered “partially trained” if a model can be further trained to fine-tune the model, for example, to better perform a specific task. An example of a partially trained ML model may be a pre-trained ML model. In some embodiments, a pre-trained confidence model 612 may be trained on ML platform 329 using multiple customer's data, and then further trained on either ML platform 329 or mobile ML platform 310 using a single customer's data. In some embodiments, a pre-trained confidence model 612 generated by a third party may be obtained and trained using transfer learning to repurpose the pre-trained confidence model 612 to recognize the classes identified herein. The transfer learning may be conducted at ML platform 329 and may involve training as disclosed herein.

“Further train,” “further trained,” or “further training” should not be interpreted to mean that a model has already been at least partially trained before being “further trained.” Rather “further train,” “further trained,” or “further training” may refer to an ML model that was partially trained and has now undergone additional training, or may refer to an ML model that was entirely untrained and has undergone some training. Accordingly, “further trained” indicates that a model receives additional training, refinement, updating, etc., than it previously had. Likewise, “train,” “training,” or “trained” should not be interpreted to mean in all cases that a model is fully trained (e.g., using a particular method or at a particular location in remote deposit system architecture 300) and cannot be refined or updated further, but only that some amount of training is being or has been performed (e.g., using a particular method or at a particular location).

Additionally or alternatively to the categorization data described above, in some embodiments, the categorization data may include field- and/or word-level labels indicating whether individual fields or words were successfully OCR processed. In such embodiments, confidence model 612 may be further trained using the field- and/or word-level labels and may develop the ability to provide field or word-level OCR success predictions. In such embodiments, mobile banking app 304 or further trained confidence model 612 may be configured to determine the likelihood a check image will be successfully processed via OCR to obtain deposit data based on the field or word-level OCR success predictions.

Additionally or alternatively, in some embodiments, the categorization data may include labels indicating raw confidence scores associated with field, word, and/or character extractions by OCR module 604. In such embodiments, confidence model 612 may be further trained using the raw confidence scores and may develop the ability to provide field- or word-level OCR success predictions (e.g., in the form of predicted field- or word-level OCR extraction confidence scores). In such embodiments, mobile banking app 304 or further trained confidence model 612 may be configured to determine the likelihood a check image will be successfully processed via OCR to obtain deposit data based on the predicted field- or word-level OCR extraction confidence scores. In related embodiments, rather than or in addition to pass/fail labels, the categorization data may include a label indicating a total image confidence score calculated from the raw confidence scores. In such embodiments, the total image confidence score may be used in further training a regression ML model that may be configured to determine a confidence score alone as its output, the confidence score indicating a likelihood a check image will be successfully processed via OCR.

As used herein, a label may be an automatically applied (e.g., at the direction of computer programs operating on client device 302, cloud banking system 316, or third party servers) or a manually applied label.

In some embodiments, along with pass images 608, fail images 610, and categorization data, metadata 605 may be provided to the untrained or partially trained confidence model 612 to further train confidence model 612. For example, the movement data described herein may be provided with individual pass images 608 and individual fail images 610 to the untrained or partially trained confidence model 612. In some embodiments, metadata 605 may be passed with check images 603 through OCR module 604 and/or categorization module 606, such that each of pass images 608 and fail images 610 is linked with items of metadata 605 as OCR processing and categorization is conducted. In alternative embodiments, metadata 605 may be provided directly to confidence model 612 and linked with individual pass images 608 and fail images 610 after OCR processing and categorization is conducted. In some embodiments, items of metadata 605 and individual pass images 608/fail images 610 may be linked based on an identifier (e.g., a numeric or alphanumeric identifier) that is shared by the items of metadata 605 and the individual pass image 608/fail image 610. In some embodiments, the identifier may include a timestamp. In some embodiments, each of check images 603 may be associated with an identifier, and each identifier may remain associated with each check image 603 throughout the process of the check images 603 being categorized as pass images 608 and fail images 610.

In some embodiments, one or more of pass images 608 may include a blurry portion (i.e., a portion which, if the portion included text, the text would not be able to be extracted using OCR processing). For example, portions of one or more pass images 608 may be blurry while at least portions of the check depicted in the one or more pass images 608 may be clear. As a non-limiting example, this may occur if the one or more pass images 608 were captured in portrait mode. Confidence model 612 may learn to recognize when blurry portions of an image will not prevent OCR processing of the image, for example, if only portions near the borders of an image are blurry. Accordingly, confidence model 612, when further trained, may be configured to recognize when blurry portions of an image will not prevent OCR processing of the image. This may provide a technical improvement over current systems, which may reject an image based on blurriness when only non-substantive portions of the image are blurry. In contrast, once further trained, confidence model 612 may be configured to approve an image for further OCR processing even if substantial portions of the image are blurry, as long as the blurry portions do not prevent necessary data from being extracted using OCR processing.

In some embodiments, pass images 608, fail images 610, categorization data, and/or associated metadata 605 may be provided to an untrained or partially trained confidence model 612 simultaneously to further train confidence model 612. In alternative embodiments, pass images 608, fail images 610, categorization data, and/or associated metadata 605 may be provided to untrained or partially trained confidence model 612 one image at a time to further train confidence model 612, for example, at a frequency determined by remote deposit activity of one or more customers of mobile banking app 304. In such embodiments, image collection 602 need not represent a collection of images gathered and jointly processed to create training data, but may represent images processed and submitted to untrained or partially trained confidence model 612 as they are received from customers of mobile banking app 304. In such embodiments, confidence model 612 may be exist in a passive state (e.g., while it is being further trained) for a predetermined time before being activated on client device 302 and/or downloaded to client device 302. In some embodiments, the predetermined time may be based on a threshold number of images used to further train confidence model 612 (e.g., confidence model 612 is in the passive state until the threshold number is reached, when it is automatically activated and/or downloaded). In some embodiments, confidence model 612 may be further trained at ML platform 329. Alternatively, or in addition, confidence model 612 may be further trained at mobile ML platform 310.

In some embodiments, pass images 608 and/or fail images 610 may be provided to untrained or partially trained confidence model 612 without any user-specific data (e.g., payer name, payee name, amount, date, etc.).

Confidence model 612, when untrained or partially trained, may be an ML algorithm. Example ML algorithms that may be used include linear regression, logistic regression, neural networks, decision tree, support vector machine (SMV), random forest, naive Bayes, k-nearest neighbor (k-NN), and approximate nearest neighbor (ANN), as appropriate for the embodiments discussed herein.

In some embodiments, an untrained or partially trained confidence model 612 may receive pass images 608, fail images 610, categorization data, and optionally metadata 605, and may determine, based on pass images 608, fail images 610, categorization data, and optionally metadata 605, a plurality of parameters (based on the pixel data and/or metadata 605 provided) and weights associated with the parameters, the weights indicating an importance of each parameter in determining a dependent variable such as image/field classification or image/field confidence score.

In some embodiments, during the training process, confidence model 612 may be configured to identify interdependencies among parameters and alter weights based on the values of other parameters within a data set. In such embodiments, confidence model 612 may determine that the level of association of a value of one parameter with a label of check image 603 changes when the value of another parameter changes. For example, confidence model 612 may determine that the level of association of a movement data value(s) with a label of a check image 603 is greater when shutter speed is slower and/or distance from the camera to the check is smaller. In this example, confidence model 612 may learn to weight movement data more highly as shutter speed decreases and/or distance decreases. In such embodiments, confidence model 612 may store rules for how to determine a weight of a parameter based on the values of other parameters associated with an image provided to confidence model 612. In such embodiments, confidence model 612 may, upon receipt of a deposit check image 616, apply these rules and set weights of the model being implemented to assess the deposit check image 616 based on the rules. In some embodiments, confidence model 612 may obtain a similar effect (i.e., consideration of interdependent impact of values of multiple parameters on classification and/or confidence score) by implementing a k-NN or ANN algorithm where one or more parameters determined by confidence model 612 (e.g., types of image metadata) may be the dimensions of the feature space. In such embodiments, a k-NN algorithm may be a weighted k-NN algorithm.

In some embodiments, for example, when a k-NN or ANN algorithm is used to train confidence model 612, confidence model 612 may be configured to perform a comparison of a deposit check image 616 with training images (e.g., pass images 608/fail images 610) and determine a classification of deposit check image 616 based on the comparison. For example, confidence model 612 may be configured to identify one or more training images that are most similar to deposit check image 616 (e.g., nearest neighbor(s)), and predict the classification of deposit check image 616 based on the categorization data associated with the identified one or more training images. In some embodiments, confidence model 612 may provide a confidence score associated with the predicted classification that is based on both the categorization data associated with the identified one or more training images and the similarity of the deposit check image 616 with the identified one or more training images. In embodiments in which confidence model 612 is further trained using only pass images 608, the confidence score may be based only on the similarity of the deposit check image 616 with at least one training image.

In some embodiments, the comparison of deposit check image 616 and training images may be performed even if no or minimal metadata 605 is used to further train confidence model 612, for example, by comparing pixel data alone (e.g., a pixel-by-pixel comparison) or pixel data and metadata describing the position and orientation of the camera relative to the captured images at the times of capture.

In the example of a k-NN or ANN trained model, in some embodiments, the most similar training image(s) may be identified based on the Euclidean distance between images as mapped onto a feature space, where the dimensions of the feature space are the parameters determined by confidence model 612 (e.g., based on input pixel data and/or metadata) and position in the feature space is determined by the values of the parameters for a given image. Alternatively, or in addition, the most similar training image(s) may be identified based a summation of differences between pixel data of corresponding pixels of two images (L1 distance metric or Euclidean). Any distance metric may be used, for example, Euclidean, Manhattan, Minkowski, Chebychev, or Cosine Similarity. While k-NN and ANN algorithms are discussed above, any ML algorithm may be used to train confidence model 612 for performing image comparisons, which may include pixel-by-pixel and/or metadata comparisons.

When further trained, confidence model 612 may be an ML model configured to determine a likelihood a deposit check image 616 will be successfully processed via OCR to obtain deposit data. In some embodiments, the likelihood may be provided as a binary classification (pass/fail). In some embodiments, the likelihood may be provided as a confidence score alone (i.e., without an associated classification). In some embodiments, the likelihood may be provided as a prediction (e.g., a classification) associated with a confidence score determined by the further trained confidence model 612. For example, upon being provided a deposit check image 616, the further trained confidence model 612 may provide a classification of “pass” along with a percentage indicating how confident the further trained confidence model 612 is that the prediction is correct, based on its training data, pixel data of deposit check image 616, and/or metadata 618 associated with deposit check image 616.

In some embodiments, deposit check image 616 may be an image of a check captured by a customer of mobile banking app 304 using a client device 302. In some embodiments, deposit check image 616 may include pixel data such as that described above for check images 603. The determination of the likelihood the deposit check image 616 will be successfully processed via OCR to obtain deposit data may be based on the pixel data. In some embodiments, the determination of the likelihood the deposit check image 616 will be successfully processed via OCR to obtain deposit data may further be based on metadata 618. Metadata 618 may include values for any one or a combination of the parameters identified above for metadata 605. Additionally, metadata 618 may be associated with and/or linked with deposit check image 616 in the same manner metadata 605 may be associated with and/or linked with check images 603, as described above.

Items of metadata 618 may be determined using one or more onboard sensors 514. In some embodiments, the further trained confidence model 612 may be configured to receive metadata 618 and base its prediction regarding deposit check image 616 on metadata 618, which may include movement data. Since metadata 618 may include movement data (e.g., linear and/or angular acceleration and/or velocity data as described above for metadata 605), the use of metadata 618 may yield a more accurate prediction of whether deposit check image 616 will pass OCR processing, given that movement at the time of image capture may produce blurriness that would prevent OCR processing from extracting data from an image.

Further, in embodiments in which metadata 605 includes individual component movement data values (e.g., linear acceleration along x, y, and z axes), confidence model 612 may be further trained on such component movement data values. Accordingly, when being further trained, confidence model 612 may identify component movement data parameters (e.g., x-axis acceleration, y-axis acceleration, z-axis acceleration) and assign a weight to each component movement data parameter. These weights may not be equal. For example, while being further trained, confidence model 612 may determine that horizontal acceleration (e.g., along the x axis in a standard camera coordinate system) is more predictive of an image being classified within fail images 610 than is vertical acceleration (i.e., sideways movement of a camera may produce more blurry images than vertical movement). In some embodiments, metadata 618 may include individual component movement data values and the prediction of whether deposit check image 616 will pass OCR processing may be based on such individual component movement data values. For example, metadata 618 may include a nonzero vertical acceleration value but no nonzero horizontal acceleration value. Based on its further training, in which it determined that vertical acceleration should be weighted less heavily than horizontal acceleration, confidence model 612 may weight acceleration provided in metadata 618 less heavily than if no component level data had been considered in the further training of confidence model 612. Accordingly, in some embodiments, considering component level data may increase the accuracy of confidence model 612 and reduce false negatives.

While vertical and horizontal acceleration are discussed above for illustrative purposes, while being further trained, confidence model 612 may determine that any component movement data parameter should be weighted more heavily than any other component movement data parameter (e.g., vertical acceleration may be weighted more heavily than horizontal acceleration, or angular velocity around one axis may be weighted more heavily than angular velocity around another axis, etc.).

While the above description discusses the use of image metadata, and particularly movement data, in the further training and implementation of confidence model 612, in some embodiments, confidence model 612 may be further trained and implemented using no metadata (i.e., only using pixel data). In such embodiments, metadata may still be included with check images 603 and/or deposit check image 616 (e.g., to identify or otherwise process a check image), but confidence model 612 need not consider the metadata in further training or determining a likelihood a check image will pass OCR processing.

In some embodiments, confidence model 612 may be further trained on a remote platform (e.g., ML platform 329) and implemented at a mobile ML platform on a client device (e.g., mobile ML platform 310). In alternative embodiments, confidence model 612 may be further trained and implemented at ML platform 329. In further alternative embodiments, confidence model 612 may be further trained and implemented at mobile ML platform 310. In some embodiments, confidence model 612 may be initially further trained at ML platform 329, implemented at mobile ML platform 310, and continuously trained at mobile ML platform 310. In some embodiments, confidence model 612 may be further trained and/or implemented at a third party server. In some of such embodiments, providing data (e.g., images and/or categorization data) to the further trained confidence model 612 may include providing the data to an API or other intermediary software implemented on the third party server that then provides the data to the further confidence model 612. Likewise, receiving data (e.g., a confidence score) from the further trained confidence model 612 may include receiving data from the API or other intermediary software that is in communication with the further trained confidence model 612.

Continuous training of confidence model 612 may be performed at ML platform 329, mobile ML platform 310, and/or a third party server. In some embodiments, continuous training of confidence model 612 may include providing to confidence model 612 a deposit check image 616 (with or without metadata 618), receiving from confidence model 612 a likelihood (e.g., a confidence score or binary determination) that the deposit check image 616 will be successfully processed via OCR to obtain deposit data, and forwarding the deposit check image 616 for OCR processing (e.g., by OCR module 604). In some embodiments, the continuous training may further include determining the result of the OCR processing, labeling deposit check image 616 according to the result (e.g., using categorization module 606), and providing the labeled deposit check image 616 (with or without metadata 618) back to confidence model 612 for training.

In some embodiments, deposit check image 616 may be forwarded for OCR processing regardless of the likelihood it will be successfully processed as determined by confidence model 612, for example, to generate more training data. In alternative embodiments, deposit check image 616 may be forwarded for OCR processing only in response to a high likelihood it will be successfully processed (e.g., a confidence score meets a predetermined threshold or a binary determination indicates “pass”), for example, as part of a standard remote deposit process implementing confidence model 612.

In some embodiments, the labeled deposit check image 616 may be provided back to confidence model 612 for training regardless of the result of the OCR processing. In alternative embodiments, deposit check image 616 may be labeled and provided back to confidence model 612 for training only if the result of the OCR processing disagrees with confidence model 612's prediction. For example, labeled deposit check image 616 may be provided back to confidence model 612 for training if confidence model 612 indicated deposit check image 616 would pass OCR processing, but deposit check image 616 failed OCR processing. In such alternative embodiments, confidence model 612 may be refined by continuous training using outliers which represent weaknesses in confidence model 612. Accordingly, confidence model 612 may be refined while minimizing processing costs associated with labeling and providing every deposit check image 616 to confidence model 612 for continuous training.

In embodiments in which confidence model 612 may be continuously trained at mobile ML platform 310, a refined version of confidence model 612 may be implemented without a customer needing to download a new of version of mobile banking app 304. In embodiments in which confidence model 612 may be continuously trained at ML platform 329, a customer may need to download a new version of mobile banking app 304 to implement a refined version of confidence model 612, which may be bundled with the new version of mobile banking app 304.

As shown in FIG. 6, in some embodiments, ML system 600 may include a diagnostic model 614. In some embodiments, diagnostic model 614 may be a deep learning model. Example deep learning algorithms used to train diagnostic model 614 may include convolutional neural networks (CNNs), recurrent neural networks (RNNs), long short term memory networks (LSTMs), generative adversarial networks (GANs), radial basis function networks (RBFNs), multilayer perceptrons (MLPs), self organizing maps (SOMs), deep belief networks (DBNs), and restricted Boltzmann machines (RBMs).

In some embodiments, diagnostic model 614 may be a deep learning model configured to analyze uncategorized data, such as image collection 602 without any labels, and determine a plurality of binary or continuous classifications of check images 603. For example, diagnostic model 614 may classify check images 603 into images that likely passed OCR processing and images that likely failed OCR processing. Further, in such embodiments, diagnostic model 614 may be configured to determine a plurality of parameters 620 and weights 622 associated with the parameters based on the uncategorized data, wherein a weight 622 indicates an importance of a parameter 620 in determining check image classification. In some embodiments, diagnostic model 614 may be configured to receive individual deposit check images 616 (with or without associated metadata 618), for example, to continuously refine parameters 620 and weights 622. In some embodiments, diagnostic model 614 may be further trained, from an untrained or partially trained diagnostic model 614, using the same or similar data as confidence model 612.

In some embodiments, parameters 620 and/or weights 622 determined by diagnostic model 614 may be used to fine tune confidence model 612. For example, weights determined in the training process of confidence model 612 may be updated based on weights 622. In some embodiments, the updated weights may be weights associated with parameters or associated with “distance” from a neighbor data point (image) (e.g., if confidence model 612 was trained using a k-NN algorithm). In some embodiments, using parameters 620 and/or weights 622 determined by a deep learning model to fine tune a predictive ML model (e.g., an image classification ML model) may cause the predictive ML model to yield more accurate results, minimizing processing costs and customer frustration associated with passed images later being rejected.

In some embodiments, diagnostic model 614 may be configured to identify interdependencies among parameters 620 and alter weights 622 based on the values of other parameters within a data set. In such embodiments, diagnostic model 614 may determine that the level of association of a value of one parameter with a label of check image 603 changes when the value of another parameter changes. For example, confidence model 612 may determine that the level of association of a movement data value(s) with a label of a check image 603 is greater when shutter speed is lower and/or distance from the camera to the check is smaller. In this example, diagnostic model 614 may learn to weight movement data more highly as shutter speed decreases and/or distance decreases. In such embodiments, diagnostic model 614 may store rules for how to determine a weight of a parameter based on the values of other parameters associated with an image provided to confidence model 612. In such embodiments, diagnostic model 614 may provide the rules to confidence model 612, either to update similar rules determined by confidence model 612 as discussed above or so that confidence model 612 does not need to determine the rules.

In some embodiments, diagnostic model 614 may be further trained on a remote platform (e.g., ML platform 329) and implemented at a mobile ML platform on a client device (e.g., mobile ML platform 310). In alternative embodiments, diagnostic model 614 may be further trained and implemented at ML platform 329. In further alternative embodiments, diagnostic model 614 may be further trained and implemented at mobile ML platform 310. In some embodiments, diagnostic mode 614 may be initially further trained at ML platform 329, implemented at mobile ML platform 310, and continuously trained at mobile ML platform 310. In some embodiments, confidence model 612 and diagnostic model 614 may be implemented together at mobile ML platform 310. In some embodiments, confidence model 612 may be implemented at mobile ML platform 310 while diagnostic model 614 may be implemented at ML platform 329. In some embodiments, both confidence model 612 and diagnostic model 614 may be implemented at ML platform 329. In some embodiments, ML system 600 may include no diagnostic model 614.

In some embodiments, diagnostic model 614 may be configured to identify check images 603 that share one or more characteristics (e.g., based on pixel data and/or metadata 605) and identify one or more categories of common check images. In some embodiments, diagnostic model 614 may provide these one or more categories and the identifiers of images that make up the categories to confidence model 612. In some embodiments, deposit check image 616 may be categorized (e.g., by confidence model 612 and/or diagnostic model 614) prior to being compared with training check images as described above, such that the comparison may be performed more quickly (e.g., by comparing deposit check image 616 only to common check images or only to check images that share a category with deposit check image 616).

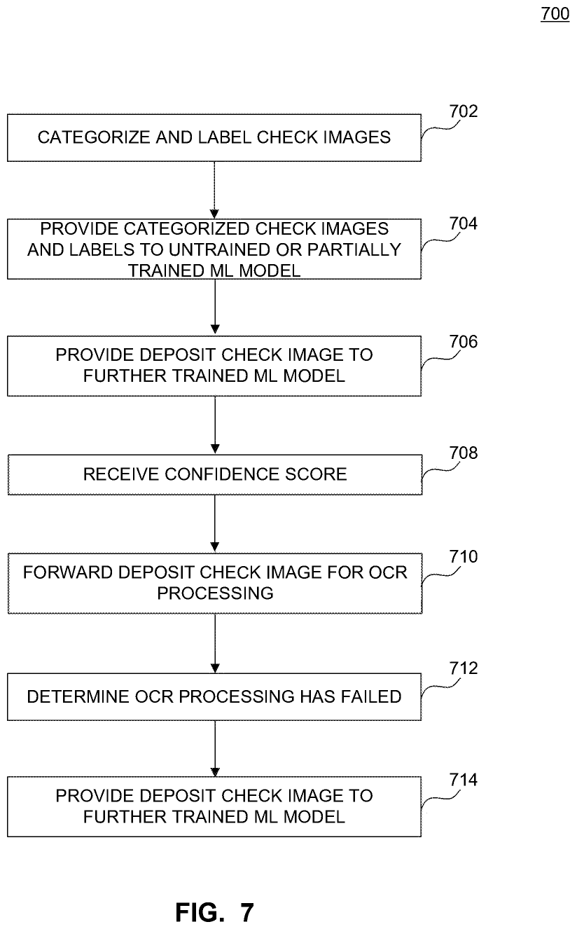

FIG. 7 is a flow chart depicting a method 700 that can be carried out in line with the discussion above. One or more of the operations in the method depicted by FIG. 7 could be carried out by one or more entities, including, without limitation, client device 302, cloud banking system 316, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described train and implement a predictive ML model for conducting a real-time image assessment prior to image upload and/or OCR processing.

Unless stated otherwise, the steps of method 700 need not be performed in the order set forth herein. Additionally, unless specified otherwise, the steps of method 700 need not be performed sequentially. The steps may be performed in a different order or simultaneously. Further, method 700 may not include all the steps illustrated. For example, in some embodiments, method 700 may not include steps 708, 710, 712, and 714. In some embodiments, method 700 may not include step 708, for example, if a binary determination rather than a confidence score is provided by the further trained ML model of step 706. In some embodiments, method 700 may not include step 712, for example, if the deposit check image of step 710 is provided to the further trained ML model in step 714 for continuous training regardless of whether OCR processing has failed or succeeded. In some embodiments, method 700 may not include steps 702, 704, 712, and/or 714, for example, if a further trained ML model is trained entirely by a third party and only implemented within remote deposit system architecture 300. In some embodiments, the “categorizing” of step 702 may include categorizing check images into OCR pass/fail groups. Alternatively or additionally, in some embodiments, the “categorizing” of step 702 may include categorizing elements of check images (e.g., assigning individual fields or words to OCR pass/fail groups or OCR extraction confidence scores). Alternatively or additionally, in some embodiments, the “categorizing” of step 702 may include categorizing check images by assigning a total image confidence score.

Step 702 may include categorizing a collection of check images (e.g., image collection 602) into a first plurality of check images (e.g., pass images 608) that have successfully been processed via OCR to obtain deposit data and a second plurality of check images (e.g., fail images 610) that have failed OCR processing. Step 702 may include associating categorization data (e.g., via labels as described with respect to FIG. 6) with each of the first plurality of check images and each of the second plurality of check images.

Step 704 may include providing the first plurality of check images, the second plurality of check images, and the categorization data to an untrained or partially trained machine learning (ML) model to obtain a further trained ML model (e.g., confidence model 612).

Step 706 may include providing a deposit check image (e.g., deposit check image 616) to the further trained ML model. In some embodiments, prior to being provided to the further trained ML model, the deposit check image may be manually captured by a user.

Step 708 may include receiving a confidence score from the further trained ML model, the confidence score indicating a likelihood the deposit check image will be successfully processed via OCR to obtain deposit data.

Step 710 may include forwarding the deposit check image for OCR processing. In some embodiments, the deposit check image may be forwarded in response to the confidence score meeting a predetermined threshold. In some embodiments, step 710 may include providing, via a mobile device (e.g., mobile computing device 102), a status (e.g., image acceptance status 416) of the deposit check image to a user prior to forwarding the deposit check image for OCR processing.

Step 712 may include determining the OCR processing of the deposit check image has failed.

Step 714 may include providing the deposit check image to the further trained ML model to further train the further trained ML model. In some embodiments, the deposit check image may be provided in response to the OCR processing of the deposit check image having failed.

In some embodiments, method 700 may include providing (e.g., via image acceptance status 416), in response to the confidence score not meeting the predetermined threshold, instructions to a user to re-take the deposit check image.

In some embodiments, method 700 may include providing the deposit check image to a deep learning (DL) model (e.g. diagnostic model 614). In some embodiments, the DL model may be configured to identify a plurality of parameters associated with a check image and determine a plurality of weights associated with the parameters, each of the plurality of weights indicating an importance of a corresponding parameter in predicting whether a check image can be successfully processed via OCR to obtain deposit data. In some embodiments, the DL model may be implemented on a mobile device (e.g., mobile computing device 102) used to capture the deposit check image. In some embodiments, method 700 may include updating a plurality of weights of the further trained ML model based on the plurality of weights determined by the DL model.

In some embodiments, method 700 may include providing onboard sensor data (e.g., as metadata 618) associated with the deposit check image to the DL model with the deposit check image. In some embodiments, the onboard sensor data may include at least one of accelerometer data from a time of the deposit check image capture or gyroscope data from the time of the deposit check image capture. In such embodiments, the plurality of parameters may include at least one of acceleration or angular velocity. In some embodiments, method 700 may include providing the onboard sensor data associated with the deposit check image to the further trained ML model with the deposit check image.

In some embodiments, method 700 may include providing instructions to a user (e.g., via image acceptance status 416) to modify a condition of image capture based on a value of a parameter associated with a check image captured prior to the deposit check image. For example, in some embodiments, the value of the parameter may have been determined by the DL model to be a factor causing the check image captured prior to the deposit check image to fail an initial image assessment.

In some embodiments, method 700 may include adjusting the predetermined threshold based on a failure rate of OCR processing of forwarded deposit check images (i.e., a rate of disagreement between the “pass” predictions of the further trained ML model and/or mobile banking app 304 and OCR processing results). In some embodiments, for example, if the failure rate is too high, the predetermined threshold may be made stricter such that a greater percentage of images predicted to pass OCR processing actually do.

In some embodiments, method 700 may include automatically capturing the deposit check image in response to the confidence score meeting the predetermined threshold, wherein the deposit check image comprises an image frame of a live stream of image frames. In some embodiments, the deposit check image may be automatically captured in response to a binary “pass” prediction, with or without a confidence score.

While the above disclosure describes training and implementing predictive ML model(s) on check images, this disclosure contemplates using images of any document that undergoes OCR processing as part of a data exchange process. For example, in some embodiments, images of any other type of financial instrument (e.g., money orders) may be used. Additionally, in some embodiments, the training and implementing of predictive ML model(s) to provide a real-time image assessment prior to upload and/or OCR processing may be used with documents such as identification documents (e.g., drivers licenses, passports, birth certificates, social security cards, etc.), with the same technical benefits. Successful OCR processing may be dependent upon a document type and purpose for submission of the document to a remote processing system. However, systems that implement OCR processing to extract data will have clear definitions of what constitutes successful OCR processing, such that the ideas of this disclosure may be applied broadly and consistently to various document types.

The solutions described above provide technical solutions to shortcomings of current remote deposit image capture processes. The various embodiments solve at least the technical problems associated with predicting in real-time, for example, prior to image upload and/or OCR processing, whether an image of a financial instrument will be able to be successfully processed to extract data necessary for execution of a transaction, resulting in a more efficient remote deposit process and user experience. The various embodiments encompassed by the technology disclosed herein are able to provide accurate predictions of OCR processing results mid-image capture experience, in some cases, before the customer completes the transaction, to avoid requiring the customer to wait to provide additional new image captures post extensive image quality checks or OCR processing. The various embodiments described herein also aid the user with easily and properly recapturing an image, which may be a technical shortcoming and user pain-point of existing systems.

Additionally, the solutions described above provide a means of quickly flagging financial instrument images that may pose a risk of fraud. For example, if a pixel-by-pixel comparison of a submitted check image to a collection of previously submitted images (e.g., using an ML model) shows little similarity to any previously submitted images, the submitted check image may be flagged as a potential fraud risk and further investigation may be performed.

### Example Computer System

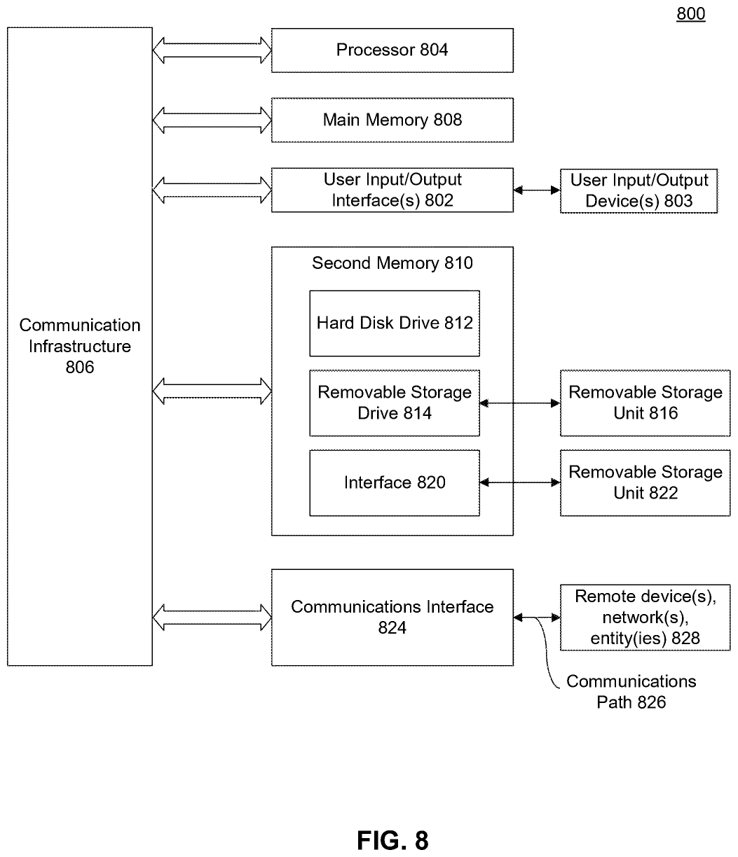

FIG. 8 depicts an example computer system useful for implementing various embodiments.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 800 may include one or more processors (also called central processing units, or CPUs), such as a processor 804. Processor 804 may be connected to a communication infrastructure or bus 806.

Computer system 800 may also include customer input/output device(s) 802, such as monitors, keyboards, pointing devices, etc., which may communicate with communication infrastructure 806 through customer input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 816. Removable storage unit 816 may include a computer usable or readable storage device having stored thereon computer software (control logic) and/or data. Removable storage unit 816 may be a floppy disk, magnetic tape, compact disk, DVD, optical storage disk, and/any other computer data storage device. Removable storage drive 814 may read from and/or write to removable storage unit 816.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 816 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The breadth and scope of the present disclosure should not be limited by any of the above-described exemplary embodiments, but should be defined only in accordance with the following claims and their equivalents.

What is claimed is:

1. A computer-implemented method for a remote deposit environment, comprising:
categorizing a collection of check images into a first plurality of check images that have successfully been processed via optical character recognition (OCR) to obtain deposit data and a second plurality of check images that have failed OCR processing;
associating categorization data with each of the first plurality of check images and each of the second plurality of check images;
providing the first plurality of check images, the second plurality of check images, and the categorization data to an untrained or partially trained machine learning (ML) model to obtain a further trained ML model;
providing a deposit check image to the further trained ML model;
receiving a confidence score from the further trained ML model, the confidence score indicating a likelihood the deposit check image will be successfully processed via OCR to obtain deposit data;
in response to the confidence score meeting a predetermined threshold, forwarding the deposit check image for OCR processing;
determining the OCR processing of the deposit check image has failed;
in response to the OCR processing of the deposit check image having failed, providing the deposit check image to the further trained ML model to further train the further trained ML model.

2. The method of claim 1, wherein the further trained ML model is implemented on a mobile device.

3. The method of claim 2, further comprising providing, via the mobile device, a status of the deposit check image to a user prior to forwarding the deposit check image for OCR processing.

4. The method of claim 2, wherein the untrained or partially trained ML model is trained on a remote platform and provided to the mobile device.

5. The method of claim 1, further comprising providing, in response to the confidence score not meeting the predetermined threshold, instructions to a user to re-take the deposit check image.

6. The method of claim 1, wherein the first plurality of check images comprises a check image comprising a blurry portion.

7. The method of claim 1, further comprising providing the deposit check image to a deep learning (DL) model, wherein the DL model is configured to identify a plurality of parameters associated with a check image and determine a plurality of weights associated with the parameters, each of the plurality of weights indicating an importance of a corresponding parameter in predicting whether a check image can be successfully processed via OCR to obtain deposit data.

8. The method of claim 7, wherein the DL model is implemented on a mobile device used to capture the deposit check image.

9. The method of claim 7, further comprising updating a plurality of weights of the further trained ML model based on the plurality of weights determined by the DL model.

10. The method of claim 7, further comprising providing instructions to a user to modify a condition of image capture based on a value of a parameter associated with a check image captured prior to the deposit check image.

11. The method of claim 7, further comprising providing onboard sensor data associated with the deposit check image to the DL model with the deposit check image.

12. The method of claim 11, wherein the onboard sensor data comprises at least one of accelerometer data from a time of the deposit check image capture or gyroscope data from the time of the deposit check image capture.

13. The method of claim 12, wherein the plurality of parameters comprises at least one of acceleration or angular velocity.

14. The method of claim 11, further comprising providing the onboard sensor data associated with the deposit check image to the further trained ML model with the deposit check image.

15. The method of claim 1, further comprising adjusting the predetermined threshold based on a failure rate of OCR processing of forwarded deposit check images.

16. The method of claim 2, further comprising automatically capturing the deposit check image in response to the confidence score meeting the predetermined threshold, wherein the deposit check image comprises an image frame of a live stream of image frames.

17. The method of claim 1, wherein the deposit check image is manually captured by a user.

18. The method of claim 2, wherein the deposit check image is captured using a camera of the mobile device.

19. A system, comprising:
at least one memory; and
at least one processor coupled to the at least one memory and configured to:
categorize a collection of check images into a first plurality of check images that have successfully been processed via optical character recognition (OCR) to obtain deposit data and a second plurality of check images that have failed OCR processing;
associate categorization data with each of the first plurality of check images and each of the second plurality of check images;
provide the first plurality of check images, the second plurality of check images, and the categorization data to an untrained or partially trained machine learning (ML) model to obtain a further trained ML model;
provide a deposit check image to the further trained ML model;
receive a confidence score from the further trained ML model, the confidence score indicating a likelihood the deposit check image will be successfully processed via OCR to obtain deposit data;
in response to the confidence score meeting a predetermined threshold, forward the deposit check image for OCR processing;
determine the OCR processing of the deposit check image has failed;
in response to the OCR processing of the deposit check image having failed, provide the deposit check image to the further trained ML model to further train the further trained ML model.

20. A non-transitory computer-readable device having instructions stored thereon that, when executed by at least one computing device, causes the at least one computing device to perform operations comprising:
categorizing a collection of check images into a first plurality of check images that have successfully been processed via optical character recognition (OCR) to obtain deposit data and a second plurality of check images that have failed OCR processing;
associating categorization data with each of the first plurality of check images and each of the second plurality of check images;
providing the first plurality of check images, the second plurality of check images, and the categorization data to an untrained or partially trained machine learning (ML) model to obtain a further trained ML model;
providing a deposit check image to the further trained ML model;
receiving a confidence score from the further trained ML model, the confidence score indicating a likelihood the deposit check image will be successfully processed via OCR to obtain deposit data;
in response to the confidence score meeting a predetermined threshold, forwarding the deposit check image for OCR processing;
determining the OCR processing of the deposit check image has failed;
in response to the OCR processing of the deposit check image having failed, providing the deposit check image to the further trained ML model to further train the further trained ML model.
